(19) United States
(12) Patent Application Publication
(10) Pub. No.: US 2019/0303349 A1
(43) Pub. Date: Oct. 3, 2019

(54) SECURITY VIA DATA CONCEALMENT

(71) Applicant: CryptoMove, Inc., Oakland, CA (US)

(72) Inventor: Boris Burshteyn, Walnut Creek, CA (US)

(21) Appl. No.: 16/443,708

(22) Filed: Jun. 17, 2019

Related U.S. Application Data
(63) Continuation-in-part of application No. 15/851,644, filed on Dec. 21, 2017, now Pat. No. 10,324,892.
Application No. 15/851,644 is a continuation of application No. 15/668,459, filed on Aug. 3, 2017, now Pat. No. 9,898,473.
Application No. 15/668,459 is a continuation of application No. 15/158,198, filed on May 18, 2016, now Pat. No. 9,753,931.
(60) Provisional application No. 62/820,163, filed on Mar. 18, 2019.
(60) Provisional application No. 62/163,804, filed on May 19, 2015.

(51) Int. Cl. G06F 16/11; G06F 21/62; H04L 9/08; H04L 9/06; H04L 29/06

(52) U.S. Cl. CPC G06F 16/122; G06F 21/6218; H04L 9/0894; H04L 9/0891; H04L 2209/16; H04L 9/0631; H04L 63/06; H04L 63/0428; H04L 9/0643

(57) ABSTRACT

Methods, apparatuses, and embodiments related to improving security of data that is stored at a data store distributed over a computer network. The methods, apparatuses, and embodiments may be implemented as a service as a cloud (SaaS) for securing secrets information including keys and secrets. In an example, security information to be protected is partitioned into multiple files, and each file is obfuscated, such as by being encrypted, to created multiple obfuscated data shards. Information as to how each obfuscated data shard was obfuscated is stored in an associated trace file. The multiple obfuscated data shards are moved around a computer network via a data movement process that includes sending each of the multiple obfuscated data shards to a different randomly selected computer, where the computer further obfuscates the obfuscated data the trace file and sends the further obfuscated data shard and trace file to a next randomly selected computer.

### CROSS REFERENCE TO RELATED APPLICATIONS

This application claims the benefit of U.S. Provisional Patent Application No. 62/820,163, filed Mar. 18, 2019, and is also a continuation-in-part of U.S. patent application Ser. No. 15/851,644, filed on Dec. 21, 2017, which is a continuation of U.S. patent application Ser. No. 15/668,459, filed on Aug. 3, 2017, now U.S. Pat. No. 9,898,473, issued Feb. 20, 2018, which is a continuation of U.S. patent application Ser. No. 15/158,198, filed on May 18, 2016, now U.S. Pat. No. 9,753,931, issued Sep. 5, 2017, which claims priority to U.S. Provisional Patent Application No. 62/163,804, filed May 19, 2015, all of which are incorporated herein by reference in their entirety.

### BACKGROUND

Security is an important concern in computer networks. One method of protecting data is to prevent unauthorized entry to a computer network via static security measures such as firewalls, passwords, dongles, physical keys, isolation, biometrics, or other measures. In spite of such measures, attackers have gained access to such theoretically secure networks. Once an attacker gains access to a network, the attacker is often able to obtain sensitive data, such as names, birth dates, social security numbers, bank account information, credit card information, intellectual property, etc. Attackers have successfully obtained such information from major corporations, such as retailers, health insurance providers, banks, etc. In some cases, an attacker is an “inside” attacker, such as an employee or some other person with authorized access to a secure network, a storage device. etc. In such cases, the attacker may be able to obtain sensitive data for nefarious purposes without needing to bypass any perimeter security that prevents unauthorized entry to the secure network.

### BRIEF DESCRIPTION OF THE DRAWINGS

One or more embodiments are illustrated by way of example in the figures of the accompanying drawings, in which like references indicate similar elements.

FIG. 1 is an illustration of a networking environment, according to some embodiments of the present disclosure.

FIG. 2 is a flow diagram that illustrates a method for continuous concealment of data, according to some embodiments of the present disclosure.

FIG. 3 is a flow diagram that illustrates a method for obfuscating source data to create multiple obfuscated data files, according to some embodiments of the present disclosure.

FIG. 4 is a flow diagram that illustrates a method for a data movement process, according to some embodiments of the present disclosure.

FIG. 5 is an illustration depicting data being moved between various computing devices, according to some embodiments of the present disclosure.

FIG. 6 is a flow diagram that illustrates a method for regenerating source data, according to some embodiments of the present disclosure.

FIG. 7 is a block diagram illustrating an example of a processing system in which at least some operations described herein can be implemented, according to some embodiments of the present disclosure.

FIG. 8 is a block diagram illustrating an example of a secrets management system in which at least some operations described herein can be implemented, according to some embodiments of the present disclosure.

FIG. 9 is a flow diagram that illustrates a method for concealment of secret information, according to some embodiments of the present disclosure.

FIG. 10 is a flow diagram that illustrates a method for retrieving concealed of secret information, according to some embodiments of the present disclosure.

FIG. 11 illustrates an example user screen of a graphical user interface (GUI) for viewing and managing secret information, according to some embodiments of the present disclosure.

FIG. 12 illustrates an example user screen of a GUI for viewing and managing secret information, according to some embodiments of the present disclosure.

FIG. 13 illustrates an example user screen of a GUI for viewing and managing secret information, according to some embodiments of the present disclosure.

FIG. 14 illustrates an example user screen of a GUI for viewing and managing secret information, according to some embodiments of the present disclosure.

FIG. 15 illustrates an example user screen of a GUI for viewing and managing secret information, according to some embodiments of the present disclosure.

FIG. 16 illustrates an example user screen of a GUI for viewing and managing secret information, according to some embodiments of the present disclosure.

FIG. 17 illustrates an example user screen of a GUI for viewing and managing secret information, according to some embodiments of the present disclosure.

FIG. 18 illustrates an example user screen of a GUI for viewing and managing secret information, according to some embodiments of the present disclosure.

FIG. 19 illustrates an example user screen of a GUI for viewing and managing secret information, according to some embodiments of the present disclosure.

### DETAILED DESCRIPTION

Introduced here is technology for improving security of data that is stored at a data store distributed over a computer network. When users encrypt and save data in a computerized persistent data store, the stored data often becomes the target of cryptographic attacks. During an attack, obtaining data of a target secret, such as encrypted data that includes the target secret, is a necessary step in the sequence of deciphering attempts. The purpose of the attack may vary from decoding the encrypted data, to understanding the encryption method, to discovering encryption keys for use in subsequent attacks, etc. However, in all cases, identifying the data to target with an attack is a mandatory condition without which no cryptographic attack can start, much less advance in achieving its goals.

Without data identification, a cryptographic attack is futile. The disclosed technology enables a continuous concealment process that obfuscates stored data, changes data names, and keeps moving the data around a distributed data store. Obfuscating data involves modifying the data in a way that increases the difficulty of determining the identity of a portion of the data. Because of this dynamic approach, unauthorized individuals, referred to herein as “attackers”, are prevented from identifying target data by its name, size, content, access time, use patterns, etc. Therefore, an attacker is prevented from attacking target data simply because the attacker does not know which data to attack. Even if an attacker attempts to get a hold of an entire data store, the attacker's chances are slim when the data store is spread over a network. At the same time, a brute force attack on a data store protected via the disclosed technology is infeasible because of its high cost in both time and computing resources. In one example. just to locate a single protected file before mounting a cryptographic attack on that protected file, according to a calculation, one has to sift through about 2⁴⁷⁶ combinations of parts in a distributed data store of 10,000 files, where each file is split into 12 parts with 4 copies (3 for backup and redundancy purposes). Note how much higher this number is than the estimated number of atoms in the Universe, which is 2²⁷². By continuously obfuscating and moving stored data, the disclosed technology makes identification of a particular protected data file practically impossible.

Just encrypting the protected file content and its name, without preventing its identification, still jeopardizes security. In a case where the attacker obtains encrypted data, the attacker might succeed in decrypting the encrypted data. Alternatively, the attacker might blackmail the encrypted data owner despite being unable to decrypt the data. Further, encryption methods considered safe today may become unsafe tomorrow because of the progress in the deciphering techniques. In some cases, an attacker may be able to apply vast amounts of computing resources, thereby enabling a successful brute force attack that results in the decryption of the protected file and access to its data. Additionally, an attacker may possess a secret algorithm that deciphers a seemingly impregnable encryption scheme. Therefore, having an attacker being able to identify the encrypted data is a serious risk in and of itself.

If the means of identification of a target file is unprotected, then an attacker may be able to choose a file just by the file name, size, content, access time, use pattern, etc. Note that sometimes an attacker is an outsider who procures help from an insider or is himself an insider familiar with the data store. Such an insider may be able to identify the data based on his insider's knowledge. Also, in some cases it is enough to identify just a portion of the needed data as the data contains references to the remaining parts. Defeating an attack by denying the ability to isolate the target data serves as strong protection, not only against an external attacker who successfully bypassed access controls, but also against an internal attacker with the proper storage access, such as a malevolent system administrator.

Some techniques for protecting data rely on preventing an attacker from gaining access to the secure network at which the data is stored. However, as is apparent from the frequent news reports of computer network breaches at major corporations and businesses, such static perimeter network security techniques are inadequate in many cases.

The disclosed technology enables a computer system, for example a computer system of a business, to protect data even when an attacker has access to the network at which the data is stored. In an example, a business protects source data via a continuous concealment process that includes an initial obfuscation process and a data movement process. The initial obfuscation process involves a computer system of the business generating multiple obfuscated data files based on the source data, where all of the obfuscated data files are needed to regenerate the source data. The initial obfuscation process includes the computer system obfuscating and partitioning the source data, which results in multiple files, and further includes the computer system obfuscating data of the multiple files, which results in the multiple obfuscated data files. Obfuscating data can include, for example, compressing, partitioning, encrypting, bit-scattering, cyclically exclusive-or'ing (XOR'ing), etc. the selected data, or adding random data to the selected data, among others.

The data movement process of the example starts with the computer system sending each of the obfuscated data files to a different initial computer system. Each of the initial computer systems initiates a propagation process that includes further encrypting, randomly renaming, and sending, after a predetermined interval, the received obfuscated data file to a randomly selected computer, which continues the propagation process by further encrypting, randomly renaming, and sending, after another predetermined interval, the obfuscated data file to another randomly selected computer. In some embodiments, after the predetermined interval, the obfuscated data file is sent to an intelligently selected computer. In some embodiments, the randomly selected names are generated so as to be unique, such as a randomly generated cryptographic name. For example, a name can be cryptographically generated based on an encryption key or seed. In other embodiments, the randomly selected names are generated randomly, but in a pre-determined fashion. In yet other embodiments, the obfuscated data file is intelligently renamed. The various computers utilized during the data movement process can be on a private network, such as computers on a private network of the business, can be part of an unbounded network, such as computers on networks of one or more cloud compute/storage providers, etc., or any combination thereof.

In order for an attacker to successfully obtain access to data protected by the disclosed technology, the attacker must first gain access to all of the obfuscated data files for the protected data. Because the obfuscated data files are randomly named and are being randomly moved amongst a pool of computers (which may span the networks of multiple independent businesses), locating the obfuscated data files is prohibitively difficult, even for an inside attacker. Further, because all of the obfuscated data files are needed to regenerate the source data, any attacker that does not possess all of the obfuscated data files is effectively prevented from successfully regenerating the source data.

In an example that helps to demonstrate the difficulty of determining the source data for even an inside attacker, a business uses the disclosed technology to protect 10,000 source files that are stored in a data store. During the initial obfuscation process for each of the 10,000 source files, each source file is processed to create 12 obfuscated data files. For redundancy and backup reasons, an additional 3 versions of each of the obfuscated data files are also created, for a total of 4 obfuscated versions of each obfuscated data file, resulting in 4*12*10,000, or 480,000 obfuscated data files in the data store.

In order to start a cryptographic attack on selected source data, a correct set of 12 obfuscated data files needs to be identified and properly aligned. However, because the 480,000 obfuscated data files cannot be distinguished from each other based on file name, size, content, access time, use pattern, etc., an attacker would need to perform a brute force attempt to identify and order a unique set of 12 obfuscated data files needed to regenerate the selected source file. An analysis based on the number of obfuscated data files and the permutations of the obfuscated data files determined that there are 2⁴⁷⁶ possible ordered combinations of obfuscated data files. As previously discussed, this number is more than the estimated number of atoms in the Universe, which is 2²⁷².

References in this description to “an embodiment,” “one embodiment,” or the like, mean that the particular feature, function, structure, or characteristic being described is included in at least one embodiment of the present disclosure. Occurrences of such phrases in this specification do not necessarily all refer to the same embodiment. On the other hand, the embodiments referred to also are not necessarily mutually exclusive.

Further, in this description the term “cause” and variations thereof refer to either direct causation or indirect causation. For example, a computer system can “cause” an action by sending a message to a second computer system that commands, requests, or prompts the second computer system to perform the action. Any number of intermediary devices may examine and/or relay the message during this process. In this regard, a device can “cause” an action even though it may not be known to the device whether the action will ultimately be executed.

Note that in this description, any references to sending or transmitting a message, signal, etc. to another device (recipient device) means that the message is sent with the intention that its information content ultimately be delivered to the recipient device; hence, such references do not mean that the message must be sent directly to the recipient device. That is, unless stated otherwise, there can be one or more intermediary entities that receive and forward the message/signal, either “as is” or in modified form, prior to its delivery to the recipient device. This clarification also applies to any references herein to receiving a message/signal from another device; i.e., direct point-to-point communication is not required unless stated otherwise herein.

Also note that in this description, any references to sending or transmitting a message, signal, etc. to another device (recipient device) means that the message is sent with the intention that its information content ultimately be delivered to the recipient device; hence, such references do not mean that the message must be sent directly to the recipient device. That is, unless stated otherwise, there can be one or more intermediary entities that receive and forward the message/signal, either “as is” or in modified form, prior to its delivery to the recipient device. This clarification also applies to any references herein to receiving a message/signal from another device; i.e., direct point-to-point communication is not required unless stated otherwise herein.

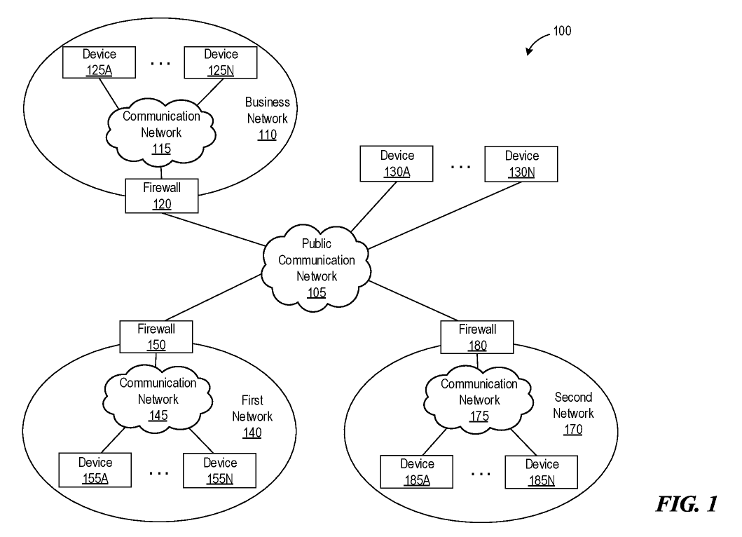

FIG. 1 is an illustration of a networking environment, consistent with various embodiments. Network environment 100 includes three networks that are protected by a firewall, business network 110, first network 140, and second network 170. Each of the three networks includes a communication network that enables data communication between computing devices that are members of the network. For example, business network 110 includes communication network 115, which includes a plurality of devices (e.g., device 125A, device 125N, etc., referred to collectively as “devices 125”), which enables devices 125 to communicate with each other, with firewall 120, etc. First network 140 includes communication network 145, which includes a plurality of devices (e.g., device 155A, device 155N, etc., referred to collectively as “devices 155”), which enables devices 155 to communicate with each other, with firewall 150, etc. Second network 170 includes communication network 175, which includes a plurality of devices (e.g., device 185A, device 185N, etc., referred to collectively as “devices 185). which enables devices 185 to communicate with each other, with firewall 180, etc.

The firewall of each of the three networks acts as a barrier to protect the network by keeping unauthorized network traffic out of the network. For example, firewall 120 protects business network 110, firewall 150 protects first network 140, and firewall 180 protects second network 170. Public communication network 105 is a public network, such as the Internet or any other public network. Public communication network 105, which includes a plurality of devices (e.g., device 130A, device 130N, etc.), enables devices 130, firewall 120, firewall 150, firewall 180, etc. to all communicate with each other.

Communication networks 115, 145, and 175, and public communication network 105, can be any type of network that enables data communication between computers. In various embodiments, one or more of communication networks 115, 145, and 175, and public communication network 105 are or include any of a local area network (LAN), a wide area network (WAN), a virtual private network (VPN), a private network, a public network, a cellular network, a short-range wireless network, a wireless local area network (WLAN), etc. The cellular network can be any of various types, such as code division multiple access (CDMA), time division multiple access (TDMA), global system for mobile communications (GSM), long term evolution (LTE), 2G, 3G, 4G, etc. The short-range wireless network, which is used for short-range wireless communications, can also be any of various types, such as Bluetooth, Bluetooth low energy (BLE), near field communication (NFC), etc. The WLAN can similarly be any of various types, such as the various types of IEEE 802.11 networks, among others. Public communication network 105 can be any type of public communication network, such as the Internet.

Devices 125, 130, 155, and 185 can be any type of computing device, such as a desktop computer, a laptop computer, a file server, a network attached storage (NAS) device, a mobile device, or a server, among others. Examples of mobile devices include smart phones, tablets, portable media devices, wearable devices, laptops, and other portable computers.

In some embodiments, first network 140 represents a first cloud storage or compute provider, and second network 170 represents a second cloud storage or compute provider, where the first and second cloud storage or compute providers are separate independent businesses.

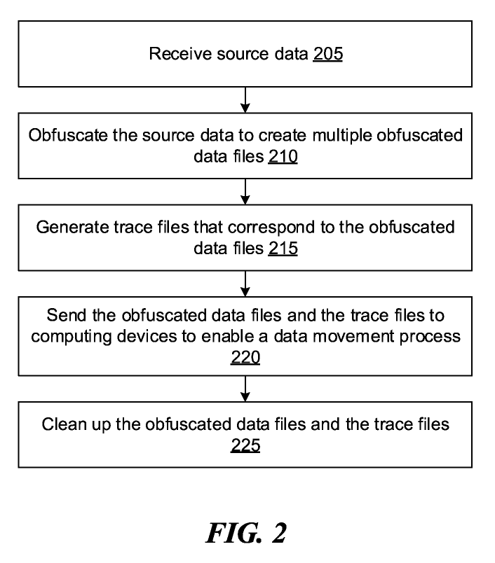

FIG. 2 is a flow diagram that illustrates a method for continuous concealment of data, consistent with various embodiments. At block 205, a computer system receives source data. The computer system can be any type of computing device, for example, any of devices 125, 130, 155, or 180 of FIG. 1, among others. Further, the computer system can receive the source data via any of various mechanisms. For example, another computer system can send the source data to the computer system, which receives the source data. As another example, a user can input the source data via an input mechanism of the computer system. Examples of input mechanisms include a word processor application, a spreadsheet application, a voice recognition application, an optical recognition application, a keyboard, a microphone, a camera, etc.

At block 210, the computer system obfuscates the source data to create multiple obfuscated data files. The multiple obfuscated data files can include one or more sets of obfuscated data files, where all obfuscated data files of any selected set of the obfuscated data files are needed to regenerate the source data. In some embodiments, multiple sets of obfuscated data files are created for redundancy or backup reasons. When multiple sets of obfuscated data files are created, any of the sets can be used to regenerate the source data.

Obfuscating selected data includes transforming the selected data, or a version of the selected data, via execution of one or more algorithms, such as a compression algorithm, a data partitioning algorithm, an encryption algorithm, a bit-scattering algorithm, a data permutation algorithm, a cyclical exclusive-or (XOR) algorithm, etc. Obfuscating selected data can further include transforming the selected data by adding random data to the selected data or a version of the selected data. In some embodiments, the encryption algorithm adds a cryptographically calculated digital digest to the selected data. For example, the encryption algorithm can utilize a Secure Hash Algorithm (SHA), such as the SHA-512 algorithm, which can append a cryptographically calculated digital digest to the selected data.

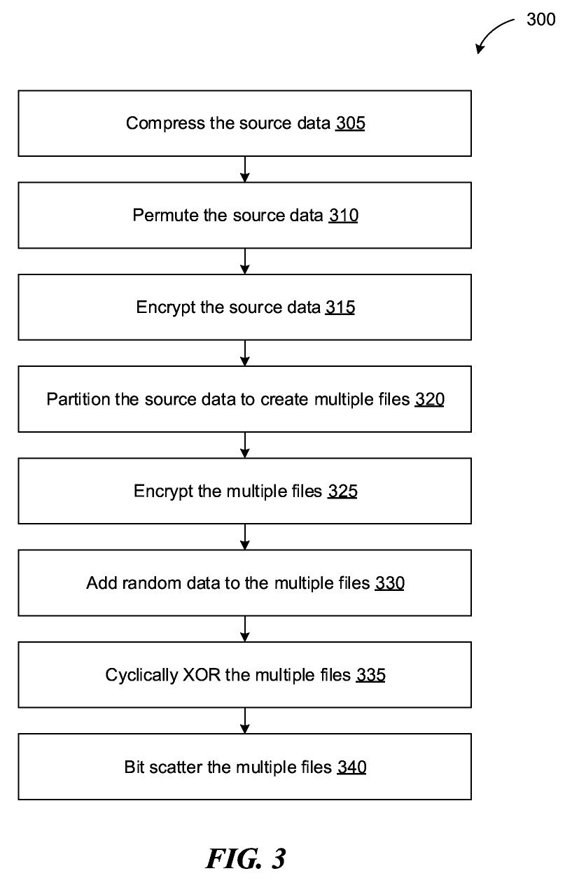

A version of selected data includes the selected data or any data that is derived from the selected data, such as data that is derived from the selected data via execution of an algorithm that transforms the selected data. Further, data that is derived from a version of the selected data is itself a version of the selected data. For example, each of the following is a version of selected source data: the selected source data; data generated via execution of a compression algorithm that takes as input the selected source data; data generated via execution of an encryption algorithm that takes as input the data generated via the execution of the compression algorithm that takes as input the selected source data. Block 210 can be implemented via the method depicted in flow diagram 300 of FIG. 3, among others. It is helpful to refer at this time to the example of FIG. 3.

FIG. 3 is a flow diagram that illustrates a method for obfuscating source data to create multiple obfuscated data files, consistent with various embodiments. Block 210 of FIG. 2 can be realized via the method of flow diagram 300, among others. At block 305, a computer system, such as the computer system of FIG. 2, compresses source data or a version of the source data by executing any of various compression algorithms, resulting in creation of a compressed version of the source data.

At block 310, the computer system permutes source data or a version of the source data by executing any of various permutation algorithms, resulting in creation of a permuted version of the source data. A permutation algorithm can permute data at any selected granularity, such as at the bit level, the byte level, the word level, the block level, etc. Permutation algorithms are well known in the art, as is demonstrated by http://www.cse.uconn.edu/˜zshi/course/cse5302/ref/yhilewitz_thesis.pdf (an archived version of which is available at https://web.archive.org/web/20160423040108/http://www.cse.uconn.edu/˜zshi/course/cse5302/ref/yhilewitz_thesis.pdf).

In some embodiments, permutation data files are stored in the data store along with obfuscated data files. Each obfuscated data file can have an associated permutation data file, which includes information as to how to reverse the permutation algorithm for the associated obfuscated data file. A permutation data file is stored in the data store as any other obfuscated data file or permutation data file. For source data, such as the source data of block 205 of FIG. 2, that is partitioned into p files (e.g., block 210, block 320), each file with c copies, there can be 2*p*c associated data files in the data store. This results from each obfuscated data file having its respective permutation, travelling the store during the data movement process independently from its associated obfuscated data file or other obfuscated data files, or other permutation data files. Permutation data files can travel in substantially the same way as obfuscated data files during the data movement process, with each permutation data file being accompanied with its own trace file.

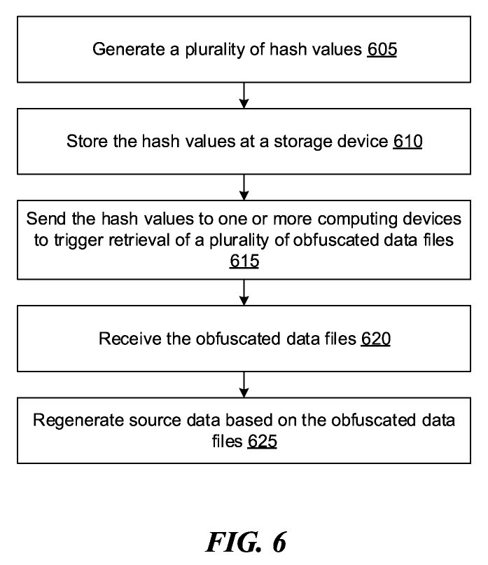

The permutation data files are not distinguishable by appearance to the computing devices, nor is the permutation data treated any differently by the computing devices than any other obfuscated data file or permutation file. When moving permutation files, computing devices send the same kind of pulse messages as are sent with obfuscated data files, and the permutation data files are retrieved together with the obfuscated data files upon data retrieval for source data regeneration (e.g., block 625 of FIG. 6). As discussed, computing devices process permutation data files and obfuscated data files in a substantially similar manner during the data movement process. However, upon retrieval of data files for source data regeneration, when an originating computer system (e.g., the computer system of block 205 of FIG. 2) receives the obfuscated data files and permutation data files retrieved for source data regeneration, the originating computer system uses data of the permutation data files to un-permute the data of the obfuscated data files.

At block 315, the computer system encrypts source data or a version of the source data by executing any of various encryption algorithms, resulting in creation of an encrypted version of the source data. In some embodiments, the encryption algorithm requires an encryption key or a seed in addition to the data to be encrypted. The encryption key or the seed can be exclusive to the computer system (e.g., used for encrypting data exclusively by the computer system, and not by any other computing device). For example, the encryption key and the seed can be exclusive to the computer system.

At block 320, the computer system partitions source data or a version of the source data by executing any of various data partition algorithms, resulting in creation of multiple files. A data partitioning algorithm divides input data into multiple output files and can divide the input data such that each of the output files is needed to regenerate the input data. The input data can be partitioned in any of various ways. For example, the input data can be partitioned into even sized, random sized, semi-random sized, etc. contiguous portions, and the contiguous portions can be used to create the output files, where each output file includes a portion of the input data that is contiguous. As another example, the input data can be partitioned into non-contiguous randomly selected portions (e.g., bit, bytes, words, blocks, etc.), semi-randomly selected portions, deterministically selected portions, etc., and the selected portions can be merged to create the output files, where each output file includes non-contiguous input data.

At block 325, the computer system encrypts the multiple files or versions of the multiple files by executing any of various encryption algorithms, resulting in creation of encrypted versions of the multiple files. In some embodiments, the encryption algorithm requires an encryption key or a seed in addition to the data to be encrypted. In some embodiments, the encryption key is private to the computer system (e.g., the encryption key is not used by any other computing device in the execution of an encryption algorithm).

At block 330, the computer system adds randomly generated data, semi-randomly generated data, deterministically generated data, etc. to the multiple files or to versions of the multiple files by executing any of various data padding algorithms, resulting in creation of padded versions of the multiple files. In some embodiments where the multiple files are of different size, the data added by the computer system causes each of the multiple files to be of a same size.

At block 335, the computer system cyclically XORs the multiple files or versions of the multiple files by executing any of various cyclical XOR algorithms, resulting in creation of XORed versions of the multiple files. In an example, a first file and a second file of the multiple files are XORed to create a version of the first file, the second file and a third file of the multiple files are XORed to create a version of the second file, etc. In some embodiments, when two files to be XORed are not of a same size, the smaller of the two files are padded with zeros, with ones, with randomly generated data, with semi-randomly generated data, with deterministically generated data, etc. to facilitate execution of the XOR algorithm. In other embodiments, when two files to be XORed are not of a same size, only the first N bits or bytes of both files are XORed. N can equal, for example, the size of the smaller of the two files.

At block 340, the computer system bit scatters the multiple files or versions of the multiple files by executing any of various bit scatter algorithms, resulting in creation of bit scattered versions of the multiple files. Bit scatter algorithms are well known in the art, as is demonstrated by the previously mentioned Hilewitz reference. In some embodiments, other algorithms that obfuscate data by transforming the data are executed to create versions of the source data or of the multiple files. The multiple obfuscated data files of block 210 of FIG. 2 can be the versions of the multiple files created by any of blocks 320 to 340 or can be versions of the multiple files created by any other algorithm that is executed as part of block 210.

Returning to FIG. 2, at block 215, the computer system generates trace files that correspond to the obfuscated data files. In some embodiments, a one to one mapping exists between the obfuscated data files and the trace files, such that each trace file maps to a single obfuscated data file, and each obfuscated data file maps to a single trace file. A trace file includes information as to how the obfuscated data file to which the trace file maps was created. For example, a trace file can include information as to the particular algorithms that were run to generate the obfuscated data file to which the trace file maps, the sequencing of the particular algorithms that were run, configuration information for the particular algorithms that were run, etc. In an example, the trace file that maps to an obfuscated data file includes information that the obfuscated data file was created by initially executing a particular compression algorithm on source data, then by executing a particular permutation algorithm, then by executing a particular encryption algorithm with a particular encryption key and seed, then by executing a particular data partition algorithm with a particular set of control values, and finally by executing the particular encryption algorithm with the particular encryption key and seed.

In some embodiments, to enable a computer system to regenerate particular source data, in addition to needing access to a set of obfuscated data files that correspond to the particular source data, the computer system needs access to the trace files that correspond to the set of obfuscated data files. The obfuscated data files are needed as the obfuscated data files contain the information of the particular source data, albeit in an obfuscated form. The trace files are needed as the trace files contain information as to how the particular source data can be regenerated based on the obfuscated data files. When the obfuscated data files were created by following a certain creation process, the trace files include information that enables the creation process to be reversed, and that enables the particular source data to be regenerated based on the obfuscated data files.

A trace file can further include identifying information for the obfuscated data file to which the trace file maps. The identifying information enables the obfuscated data file to be positively identified. In some embodiments, the identifying information is a hash value that is generated by a hash algorithm based on the contents of obfuscated data file, and that is unique to the contents of the obfuscated data file. In other words, any file that contains data that is different from the data of the obfuscated data file will have a different hash value than the obfuscated data file.

At block 220, the computer system sends the obfuscated data files and the trace files to computing devices to enable a data movement process. The computing devices of block 220 can be, for example, any of devices 125, 130, 155, or 185 of FIG. 1, among others. In some embodiments, the computer system randomly, semi-randomly, deterministically, etc. selects a first computing device from a set of computing devices, and the computer system sends a first one of the obfuscated data files, and a trace file that maps to the first obfuscated data file, to the first computing device. The computer system similarly selects a second computing device and sends a second one of the obfuscated data files, and a trace file that maps to the second obfuscated data file, to the second computing device. The computer system repeats this process until the computer system has sent all of the obfuscated data files, and the trace files that correspond to the obfuscated data files, to the computing devices of block 220.

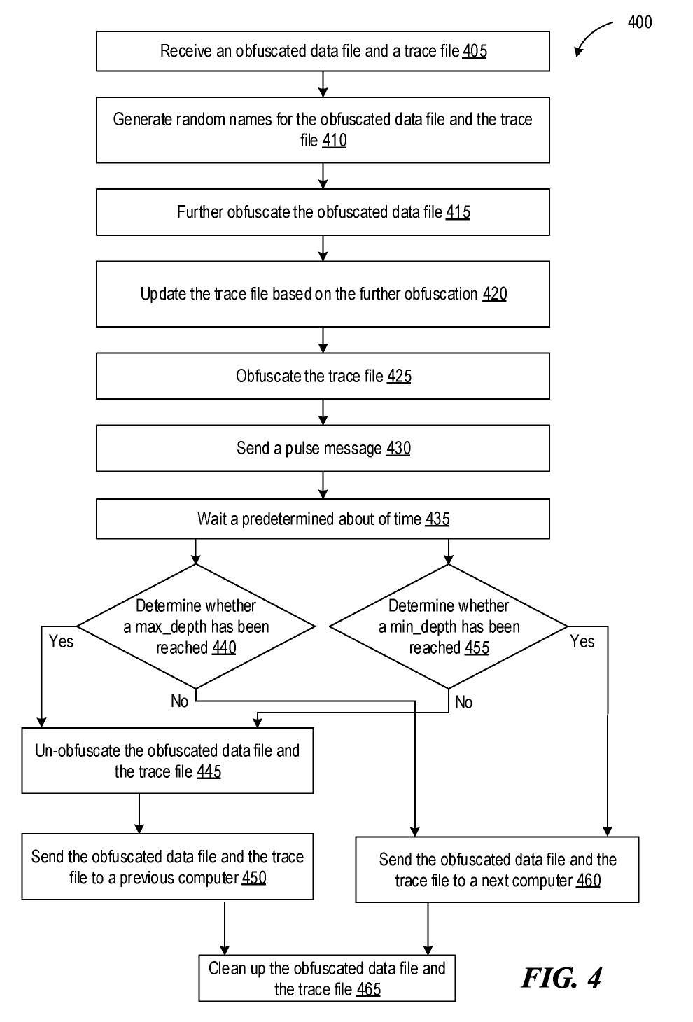

The data movement process that is enabled by the computer system sending the obfuscated data files and the trace files can be any of various data movement processes. For example, the data movement process that is enabled at block 220 can be the method depicted in flow diagram 400 of FIG. 4, among others. As previously discussed, in order for an attacker to successfully obtain access to data protected by the disclosed technology, the attacker must first gain access to all the obfuscated data files needed to regenerate the protected data. In some embodiments, the data movement process includes randomly, semi-randomly, deterministically, etc. moving the obfuscated data files amongst a pool or set of computing devices. As a result, locating the obfuscated data files is prohibitively difficult, as any of the obfuscated data files can be located on any of the computing devices.

Further, unless an attacker can freeze all the computing devices, which can be located on networks of multiple independent businesses, it is practically impossible to obtain all of the obfuscated data files needed to regenerate particular source data. For example, where source data is obfuscated to create ten obfuscated data files, the obfuscated data files can each initially be located on ten different computing devices, a first computing device through a tenth computing device. At that time, an attacker gains access to the first computing device, and is able to obtain copies of all files on the first computing device. The attacker at a later time is able to gain access to the tenth computing device. However, the obfuscated data file that was originally at the tenth computing device has been moved to an eleventh computing device, where the obfuscated data file has been renamed with another random name and has been encrypted once again.

As this example helps to demonstrate, unless an attacker can freeze all the computing devices at the same or substantially the same time, it becomes practically impossible to obtain copies of all of the needed obfuscated data files. In some embodiments where all of the obfuscated data files are needed to regenerate the source data, any attacker that does not possess all of the obfuscated data files is effectively prevented from successfully regenerating the source data. Further, even if an attacker were able to simultaneously freeze all the computing devices and obtain all data of a data store containing 10,000 files protected with a version of the disclosed technology, a brute force attack on the data store would have to sift through about 2⁴⁷⁶ combinations of parts, as per an earlier discussed example. Additionally, the simultaneous freeze could occur when an obfuscated data file is in the middle of being moved. In such a case, the attacker may not obtain a usable copy of the obfuscated data file, as the data that comprises the file may not be fully stored, but rather may be partially stored and partially in the process of being moved between computing devices.

At block 225, the computer system cleans up the obfuscated data files and the trace files. Cleaning up a selected file can include any of deleting the selected file, zero-ing out data of the selected file, freeing up storage space previously utilized to store the selected file, eliminating a pointer(s) to the selected file, etc.

FIG. 4 is a flow diagram that illustrates a method for a data movement process, consistent with various embodiments. The data movement process of FIG. 4 can be the data movement process that is enabled at block 220 of FIG. 2, among others. At block 405, a computing device receives an obfuscated data file and a trace file. The computing device of FIG. 4 can be any of devices 125, 130, 155, or 185 of FIG. 1, among others. At block 410, the computing device generates a name for the obfuscated data file, and another for the trace file, received at block 405. Each name can be generated in any of various ways, such as by being randomly generated, semi-randomly generated, deterministically generated, etc. As previously discussed, a randomly generated name can be generated in any of various ways, such as being generated so as to be unique, being generated randomly but in a pre-determined fashion, etc.

At block 415, the computing device further obfuscates the obfuscated data file to create a modified version of the obfuscated data file. As previously discussed, obfuscating selected data includes transforming the selected data, or a version of the selected data, via execution of one or more algorithms, such as a compression algorithm, a data partitioning algorithm, an encryption algorithm, a bit-scattering algorithm, a data permutation algorithm, a cyclical exclusive-or (XOR) algorithm, etc. Obfuscating selected data can further include transforming the selected data by adding random data to the selected data or a version of the selected data. In an example, the computing device obfuscates the obfuscated data file by applying an encryption algorithm that takes the obfuscated data file and an encryption key as input, and that outputs the modified version of the obfuscated data file. In this example, the encryption key is used for encrypting data exclusively by the computing device and is exclusive to the computing device.

At block 420, the computing device updates the trace file based on the further obfuscation (i.e., the further obfuscation of block 415). The update of the trace file enables the obfuscation of block 415 to be reversed, such that the obfuscated data file received at block 405 can be regenerated. In an example, the computing device updates the trace file with encryption information that enables the encryption of block 415 to be reversed (e.g., that enables an encrypted file that is the output of block 415 to be decrypted). The trace file can further be updated with identifying information for the modified version of the obfuscated data file, such as a hash value of the modified version of the obfuscated data file. The identifying information enables the modified version of the obfuscated data file to be positively identified. For example, the trace file can be updated with information as to the particular encryption algorithm used, any parameters that were used by the encryption algorithm, information as to the encryption key used, a hash value that is generated by a hash algorithm based on the contents of the modified version of the obfuscated data file and that enables positive identification of the modified version of the obfuscated data file, etc.

At block 425, the computing device obfuscates the trace file to create a modified version of the trace file. In an example, the computing device obfuscates the trace file by applying an encryption algorithm that takes the trace file and an encryption key as input, and that outputs the modified version of the obfuscated data file.

At block 430, the computing device sends a pulse message. A pulse message is a message sent to a selected computer system to notify the selected computer system of a location of a trace file or an obfuscated data file, or a selected version of a trace file or an obfuscated data file. The pulse message can include an identifier for the computing device, such as an Internet Protocol (IP) address of the computing device, a name of the computing device, a Media Access Control (MAC) address of a network interface of the computing device, a serial number of the computing device or a hardware component of the computing device, etc., The identifier can enable a reduction in a time duration needed to retrieve the obfuscated data file or the trace file. The selected computer system can be a computer system that received an initial request to protect the source data, among others. For example, the selected computer system can be the computer system of block 205 of FIG. 2.

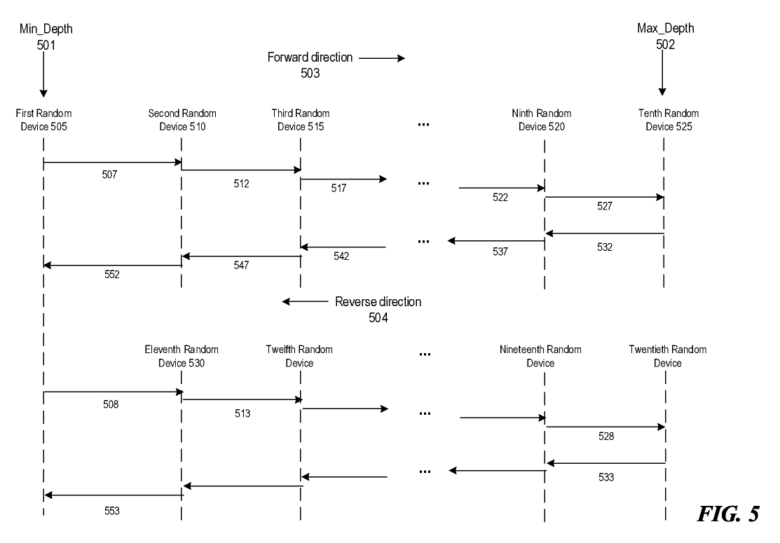

In some embodiments, a pulse message follows a same path as was followed by a trace file or an obfuscated data file as the trace file or the obfuscated data file were moved via the data movement process of FIG. 4. The pulse message leaves a pulse track file on each computing device through which the pulse message travels on its path to the computing system of origination (e.g., the computer system of block 205 of FIG. 2). FIG. 5 shows an example of an obfuscated data file being moved between various computing devices via multiple executions of a data movement process. Each pulse track file can contain a link to a previous pulse track file thus comprising a pulsing track that can lead from the selected computer system to a current location of the trace file or obfuscated data file.

When a user retrieves a saved file from a data store protected by the disclosed technology, a retrieving computer system can follow pulsing tracks from the selected computer system towards current locations of all trace files or obfuscated data files and can deliver those trace files or obfuscated data files back to the retrieving computer system. The retrieving computer system can, based on information in the retrieved trace files, combine the obfuscated data files, and reverse the obfuscation process to generate the source data.

In some embodiments, a name of a selected pulse track file, also referred to as a pulse file, can be cryptographically derived from the name of the selected trace file that initiates the pulse message. Therefore, in embodiments where trace file names never repeat, the pulse track files for different obfuscated data files never repeat their names. The pulse track files can be temporary. For example, a particular computer system can delete an existing pulse track file each time a new pulse, based on the same obfuscated data file or trace file, travels through the particular computer system. In some embodiments, pulse track files continuously change their names, disappear, and reappear under different names in the data store. In such embodiments, the difficulty of a brute force attack on the pulse track files is similar to an attack on the obfuscated data files.

At block 435, the computing device waits a predetermined amount of time. In some embodiments, a user sets the predetermined amount by inputting the predetermined amount of time into a configuration file, and the computing device accesses the configuration file, or a file derived from the configuration file, to determine the predetermined amount of time. In other embodiments, the predetermined time, after being set by a user, is added to a trace file, and the computing device accesses the trace file to determine the predetermined amount of time. In yet other embodiments, the predetermined amount of time is randomly, semi-randomly, or deterministically determined, among others.

At block 440, the computing device determines whether a max_depth has been reached. The data movement process illustrated in flow diagram 400 can be executed multiple times by multiple computing devices. For example, a first computing device can receive an obfuscated data file and a trace file, apply the method of flow diagram 400, and send the further obfuscated data file and trace file to a next computing device, which can apply the method of flow diagram 400, and send the even further obfuscated data file and trace file to another next computing device, etc.

In some embodiments, such as embodiments where the obfuscated data file is moved less often (e.g., once a month), the application of block 415 at each data movement may not be overly prohibitive, as regenerating source data would only require reversing the effects of a limited number of obfuscations due to the low movement frequency. In other embodiments, such as embodiments where the obfuscated data is moved often (e.g., once every hour), the application of block 415 at each data movement could become prohibitive, as regenerating source data could require reversing the effects of an exceptionally large number of obfuscations due to the high movement frequency. If the obfuscated data file were moved once an hour for a year (following the process of flow diagram 400), block 415 could be applied over 8,000 times, and regenerating source data could require reversing the effects of over 8,000 obfuscations. Reversing the effects of over 8,000 obfuscations to regenerate the source data could be prohibitively expensive computationally and time-wise, due to the significant amount of compute resources and time required to reverse the over 8,000 obfuscations. For example, when the obfuscation of block 415 includes executing an encryption algorithm, revering the effects of the over 8,000 encryptions can require executing over 8,000 decryptions.

To prevent such a situation from happening, in some embodiments, a maximum depth (max_depth) value is defined. The max_depth value sets a limit as to a maximum number of times that the obfuscation of block 415 will be applied to versions of an obfuscated data file during the data movement process. Similarly, a min_depth value sets a limit as to a minimum number of times that the obfuscation of block 415 will be applied to versions of an obfuscated data file during the data movement process. In some embodiments, max_depth can only be reached when a data movement process is going in a forward direction, such as when a data movement process executed per FIG. 5 is going in forward direction 503. It is helpful to refer at this time to the example of FIG. 5. FIG. 5 is an illustration depicting data being moved between various computing devices, consistent with various embodiments.

In the example of FIG. 5, first random device 505 accomplishes an initial obfuscation of source data to be protected and enables a data movement process, such as by executing the method of FIG. 2. After accomplishing the initial obfuscation of the source data to create multiple obfuscated data files (e.g., per block 210), and accomplishing an initial generation of the trace files (e.g., per block 215), first random device 505 sends one of the obfuscated data files and an associated trace file to second random device 510 (step 507) to enable the data movement process, which starts in a forward direction (e.g., forward direction 503). Second random device 510 continues the data movement process in the forward direction (e.g., forward direction 503) by sending a second-generation obfuscated data file (e.g., created at block 415) and an associated trace file (e.g., created at block 425) to third random device 515 (step 512), which continues the data movement process (step 517). A second-generation obfuscated data file is a version of the obfuscated data file. In some embodiment, a second-generation obfuscated data file is the version of the obfuscated data file after block 415 has been executed twice based on the obfuscated data file.

The data movement process continues with ninth random device 520 receiving an eighth-generation obfuscated data file (step 522) and continuing the data movement process by sending a ninth-generation obfuscated data file and an associated trace file to tenth random device 525 (step 527). Tenth random device 525 further obfuscates the ninth-generation obfuscated data file (e.g., created at block 415) to create a tenth-generation obfuscated data file. After waiting a predetermined amount of time (e.g., per block 435), tenth random device 525 determines that max_depth, which is set to 10 in this example, has been reached (e.g., per block 440).

Upon determining that the max_depth has been reached, the data movement process continues in a reverse direction (e.g., reverse direction 504) until min_depth is reached. Tenth random device 525 un-obfuscates the obfuscated data file (e.g., per block 445), to regenerate the ninth-generation obfuscated data file, and sends the ninth-generation obfuscated data file to ninth random device 520 (step 532, also e.g., per block 450), which continues the data movement process in reverse direction 504 (step 537). The data movement process continues in reverse, with third random device 515 receiving a regenerated third generation obfuscated data file (step 542), un-obfuscating the third-generation obfuscated data file (e.g., per block 445), to regenerate the second-generation obfuscated data file, and sending the regenerated second-generation obfuscated data file to second random device 510 (step 547). Second random device 510 un-obfuscates the regenerated second-generation obfuscated data file (e.g., per block 445), to regenerate the first-generation obfuscated data file, and sends the regenerated first-generation obfuscated data file to first random device 505 (step 553).

First random device 505 then determines that min_depth, which is set to 1 in this example, has been reached. Upon determination that the min_depth has been reached, the data movement process continues in forward direction 503 again, with first random device 505 sending a new second generation obfuscated data file and an associated trace file to eleventh random device 530 (step 508), which continues the data movement process in forward direction 503 (step 513). This process continues until, after step 528, max_depth is once again reached, at which time the data movement process is once again continued but in reverse direction 504 (step 533), until, after step 553, min_depth is once again reached, at which time the data movement process once again continues in forward direction 503.

It is noted that, in some embodiments, when the data movement process continues in the reverse direction, an obfuscated data file received at block 405 is obfuscated (block 415) before being stored. This avoids a case where an obfuscated data file exists on a particular computing device in a same state (e.g., with the same encrypted data) as it existed during the forward direction. As a result, an attacker will not be able to spot a same obfuscated data file on a particular computing device when the obfuscated data file is received by the computing device in the reverse direction.

Returning to the discussion of FIG. 4, at block 445, the computing device un-obfuscates the obfuscated data file and the trace file, or a modified version of the obfuscated data file and the trace file. A modified version of the obfuscated data file and the trace file were, respectively, created earlier at blocks 415 and 425. At block 445, the computing device reverses the obfuscation process to regenerate the obfuscated data file and the trace file (prior to the obfuscations of blocks 415 and 425). In embodiments where the identifying information of the trace file enables data of the obfuscated data file to be uniquely verified, such as when the identifying information is a hash value, the hash value of the trace file can be compared to a hash value calculated based on the data of the obfuscated data file. When the hash values do not match, the computing device can decide that the obfuscated data file was improperly modified and that a security breach occurred. The computing device can further determine that the previous computing device (i.e., the one that sent the improperly modified obfuscated data file to the current computing device) is a non-trusted computer and can add identifying information for the previous computing device to a trusted computer database, which is a database that enables identification of trusted and non-trusted computers.

At block 450, the computing device sends the regenerated obfuscated data file and trace file to a previous computing device. The previous computing device can be a computing device from which the obfuscated data file and the trace file were received at block 405. In some embodiments, in order to un-obfuscate an obfuscated data file, the obfuscated data file needs to be sent to a particular computing device. For example, when a particular computing device obfuscates a file by encrypting a file based on a private key, decrypting the file may require sending the file to the particular computing device, as the particular computing device may be the only computing device that has access to the private key that was used to encrypt the file.

At block 465, the computing device cleans up the obfuscated data file and the trace file. Cleaning up a selected file can include any of deleting the selected file, zero-ing out data of the selected file, freeing up storage space previously utilized to store the selected file, eliminating a pointer(s) to the selected file, etc. At block 455, the computing device determines whether a min_depth has been reached. The min_depth can be, for example, min_depth 501 of FIG. 5. In some embodiments, min_depth can only be reached when a data movement process is going in a reverse direction, such as when a data movement process of FIG. 5 is going in reverse direction 504. At block 460, the computing device sends the obfuscated data file and the trace file, or a version of the obfuscated data file and the trace file, to a next computing device. In some embodiments, the computing device randomly, semi-randomly, deterministically, etc. selects the next computing device from a set of computing devices. The set of computing devices can be, for example, any of devices A 125, 130, 155, or 185 of FIG. 1, among others.

FIG. 6 is a flow diagram that illustrates a method for regenerating source data, consistent with various embodiments. The method of FIG. 6 can be executed in conjunction with the method of FIG. 2. At block 605, a computer system, such as the computer system of FIG. 2, generates a plurality of hash values. The hash values can be the identifying information that is included, in some embodiments, in the trace files generated at block 215. Each of the hash values is generated by executing a hash algorithm based on contents of the a different one of the multiple obfuscated data files of block 210. In embodiments where each of the trace files of block 215 includes identifying information, and the identifying information is a hash value, when the obfuscated data files and trace files are sent at block 220, the trace file includes the hash value, which can be used to uniquely identify the obfuscated data file.

At block 610, the computer system stores the hash values at a storage device. The hash values can be stored in any of various ways. For example, the hash values can be stored in one or more files, in a database, etc. The one or more files, or the database can be encrypted or otherwise obfuscated. At block 615, the computer system sends the hash values to computing devices, such as the computing devices of block 220. In some embodiments, such as embodiments where the computer system receives pulse messages, the computer system sends one or more of the hash values to a computing device based on an identifier received via a pulse message. The identifier can be the identifier of block 430 of FIG. 4 and can uniquely identify the computing device that sent the pulse message that included the identifier.

When a particular computing device receives a hash value, the computing device can compare the hash value to the hash value of any of the trace files to which the computing device has access. When the received hash value matches the hash value of a trace file, the computer system can initiate a process to return the obfuscated data file that maps to the trace file to the computer system. Because the obfuscated data file is being moved as part of a data movement process that adds an additional layer of obfuscation with each data move, the process of returning the obfuscated data file can follow the data movement process, but in reverse. For example, referring to FIG. 5, if tenth random device 525 received the hash value, and if the hash value matched the hash value of a trace file received at step 527, then the obfuscated data file received at step 527 can be returned by moving the obfuscated data file and the trace file in reverse direction 504, such as via step 532, then step 537, etc., until the trace file and the obfuscated data file reach the computer system.

At block 620, the computer system receives the obfuscated data files, and the trace files associated with the obfuscated data files. At block 625, the computer system regenerates the source data based on the obfuscated data files and the trace files. Because a trace file includes information as to how the obfuscated data file to which the trace file maps was created, the computer system can use the information of the trace file to reverse an obfuscation process for the obfuscated data file that maps to the trace file. For example, when the obfuscated data files were generated at block 215 of FIG. 2, the computer system can regenerate the source data of block 205 based on the obfuscated data files of block 210, and the trace files of block 215.

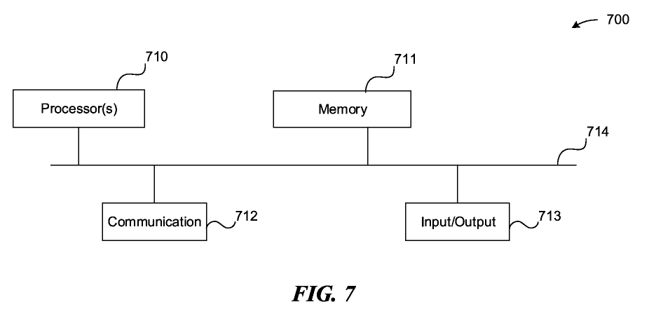

FIG. 7 is a high-level block diagram illustrating an example of a processing system in which at least some operations described herein can be implemented, consistent with various embodiments. The processing system can be processing device 700, which represents a system that can be used to implement any of the methods, algorithms, modules, and/or components described herein. For example, processing device 700 can be any of devices 125, 130, 155, or 185 of FIG. 1, among others. A system may include two or more processing devices such as represented in FIG. 7, which may be coupled to each other via a network or multiple networks. A network can be referred to as a communication network.

In the illustrated embodiment, the processing device 700 includes one or more processors 710, memory 711, a communication device 712, and one or more input/output (I/O) devices 713, all coupled to each other through an interconnect 714. The interconnect 714 may be or include one or more conductive traces, buses, point-to-point connections, controllers, adapters, and/or other conventional connection devices. Each of the processors 710 may be or include, for example, one or more general-purpose programmable microprocessors or microprocessor cores, microcontrollers, application specific integrated circuits (ASICs), programmable gate arrays, or the like, or a combination of such devices. The processor(s) 710 control the overall operation of the processing device 700. Memory 711 may be or include one or more physical storage devices, which may be in the form of random access memory (RAM), read-only memory (ROM) (which may be erasable and programmable), flash memory, miniature hard disk drive, or other suitable type of storage device, or a combination of such devices. Memory 711 may store data and instructions that configure the processor(s) 710 to execute operations in accordance with the techniques described above. The communication device 712 may be or include, for example, an Ethernet adapter, cable modem, Wi-Fi adapter, cellular transceiver, Bluetooth transceiver, or the like, or a combination thereof. Depending on the specific nature and purpose of the processing device 700, the I/O devices 713 can include devices such as a display (which may be a touch screen display), audio speaker, keyboard, mouse or other pointing device, microphone, camera, etc.

### Secrets Management System and Method

The data movement method and system disclosed herein (i.e., moving target defense) can be used to provide secrets and keys management (herein “secrets management”). The management of secrets and keys have increased drastically due to changes to infrastructure and software development processes.

For example, development and operations (DevOps) processes & microservices based architecture leads to secrets proliferation. Teams undergoing DevOps transformations move fast and manage many different infrastructure environments and services for development, testing, integration, and deployment. A DevOps team may store credentials or keys for accessing a database, third-party service provider, or other resources. Secrets management for DevOps environments is vital as part of the secure software development lifecycle.

Artificial intelligence (AI) & data analytics lead to many secrets to manage for these pipelines as well. The proliferation of IoT, robotics, and embedded device results in large volumes of secrets proliferation, due to the need to have encryption and certificates for each IoT endpoint. Blockchain projects in the enterprise also lead to more private keys than typically are used in applications. Therefore, there is a need for an “enterprise wallet” to manage all those private keys.

Secrets management is a complex and emerging problem presented with the transformation towards cloud-native, services, and IoT infrastructure. Additionally, secrets management is at the intersection of data security and application security. To address the emerging needs of secrets management, a cloud-native Software-as-a-Service (SaaS) secrets management product using a data movement network is described herein.

In terms of storing keys and secrets, secrets management tools may store keys into a database, local storage, or some other back-end. In some implementations, the stored keys and secrets are then wrapped in encryption. For enhanced security, SaaS secrets management services may use moving target defense, fragmentation, and decentralized or distributed storage of keys secrets. In some embodiments, the keys and secrets may be stored using a data movement network within environment 100 of FIG. 1. Additionally, in some embodiments, the data movement network may perform steps that are consistent with the steps described in FIGS. 2-6 and 9-10.

The SaaS secrets management should provide a management infrastructure that is reliable, resilient, and highly available. For example, the SaaS secrets management system functions whether the system is online or offline. When the system is offline (e.g., disconnected from an external network), the nodes within the system may still communicate with each other. Therefore, any functionality that require secrets management within the system may be supported between the nodes of the system.

Additionally, SaaS secrets management should be scalable to facilitate the massive scale of secrets proliferation. SaaS secrets management is highly scalable compared to traditional secrets and keys management systems that rely on hardware such as hardware security modules (HSM). HSMs are typically limited to supporting a fixed number of keys per unit. Therefore, in order to support additional secrets, more HSMs must be added to the system. In contrast, a SaaS system may be upgraded with additional processing and memory resources to dramatically increase the number of secrets that are supported.

Finally, SaaS secrets management should be well integrated with devOps stacks as well as tools in the security stack. For example, SaaS secrets management tools should integrate with various authentication options. Examples of authentication tools include Okta, OneLogin, Active Directory Federated Services (ADFS), AWS IAM roles, Auth0, etc.

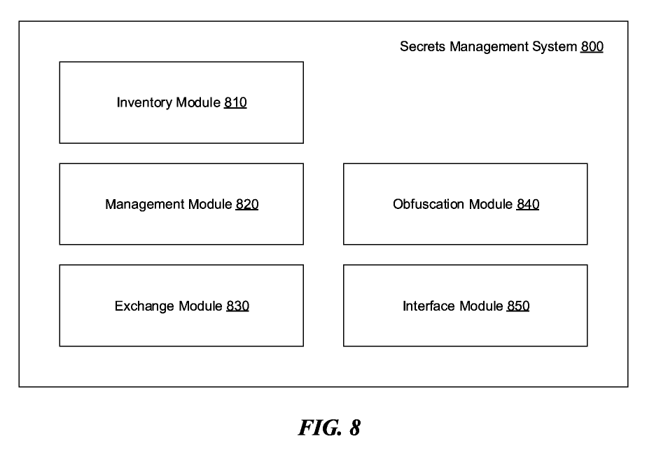

FIG. 8 is a block diagram illustrating an example of a secrets management system 800 for providing a SaaS secrets management service in which at least some operations described herein can be implemented, consistent with various embodiments. For example, the secrets management system 800 may include an inventory module 810, management module 820, exchange module 830, obfuscation module 840, and interface module 850. The secrets management system 800 can be implemented as a standalone computer, such as any one of devices 125, 130, 155, and 185 of FIG. 1. The secrets management system 800 can also be implemented as a distributed system in which various modules of the secrets management system 800 are distributed over various devices such as more than one of devices 125, 130, 155, and 185 of FIG. 1. Additionally, the various modules may be software stored on a memory and executed by a processor or an application-specific integrated circuit (ASIC) designed to execute a particular function.

In the illustrated embodiment, the secrets management system 800 includes an inventory module 810. Inventory module 810 is configured to store information regarding secret information. Secret information may be used by DevOps and other infrastructure and software development processes. For example, cloud native development & multi-cloud infrastructure results in secrets proliferation. As teams develop cloud-native applications, secrets used to authenticate users and access services for storage, computing resources, analytics, logging, and other services must be shared and managed. These resources and services all need to be mediated with secrets such as cryptographic keys, tokens, certificates, credentials, configuration variables, environmental variables, application secrets, and infrastructure secrets. Specific examples of secrets include cryptographic keys, application programming interface (API) keys, secure shell (SSH) keys, tokens, TLS certificates, credentials, configuration variables, environmental variables, application secrets, and infrastructure secrets.

In some embodiments, the inventory module 810 may be configured to store the location of a secret information and the identity of authorized entities having permission to access the secret information. For example, inventory module 810 may store a list of secret information that the secrets management system 800 is managing.

The secrets management system 800 may also include a management module 820. The management module 820 performs management tasks on the secret information. In some embodiments, management module 820 performs the tasks of secrets generation, rotation, revocation, assignment, and sharing. It is important that a secrets management tool can make the processes associated with working with secrets easy and organized. For example, management module 820 provides the capability to generate secret information. The secret information may be generated for newly granted access to new data or services. SaaS secrets management also provides auditing & usage tracking capabilities. Additionally, SaaS secrets management provides auditing & usage tracking capabilities. For example, management module 820 may allow for examining of secrets access and usage. Additionally, management module 820 may provide tracking capabilities for compiling activities associated with specific keys.

Additionally, management module 820 may communicate with exchange module 830, obfuscation module 840, and interface module 850 to determine tasks to be performed on secret information being managed. For example, management module 820 may share or assign secret information to various authorized entities possessing permission to access data or resources corresponding to the secret information. In another example, management module may rotate existing secret information. Rotating secret information may involve automatically updating the secret information. Additionally, the updated secret information may be obfuscated as discussed below. Finally, management module 820 may revoke secret information. This may occur, for example, when an authorized entity losses permission to access data or a service. By revoking the secret information such as a credential or key, secrets management system 800 ensures that the previously authorized entity no longer has access to the restricted resource.

The management module 820 may utilize an application programming interface (API) to perform the various management operations described herein. In some embodiments, the API may allow secrets management system 800 to programmatically receive commands or requests to execute secrets operations such as generating, configuring, updating, and/or exchanging secret information. Operations that are programmatically initiated means that, for example, programs may be developed to request management operations without user input. This is useful for enterprises that often have tens of thousands of machine-based identities that need to be managed and mediated via tokens, API keys, certificates, and other secrets.

The secrets management system 800 may also include an exchange module 830. The exchange module exchanges secret information with the authorized entities such as users, databases, third-party services, or other resources. In some embodiments, the exchange module 830 utilizes the API to facilitate machine identity and machine-to-machine communication. In other words, the features of the SaaS secrets management tool are accessible using a comprehensive API.

For example, the API may be provided to authenticate application components and services. Since services and business processes are increasingly automated, machine-to-machine authentication and identity via secrets management is critical. Besides APIs, the exchange module 830 also facilitates secrets operations based on user input. Users may use a user interface, such as the interface provided by interface module 850, to receive commands or requests to perform operations.

The exchange module 830 may deliver or exchange secrets in a variety of ways. For example, the exchange module 830 may transmit secrets to a user via an email or messaging software. The exchange module 830 may transmit secrets to a specifically designated user. Additionally, the exchange module 830 may transmit secrets to a large number of users by using a whitelist of authorized users. Similarly, the exchange module 830 may transmit secrets to a class of users or users associated with a tag. The exchange module 830 may use the API to programmatically deliver secrets from machine to machine without user input or intervention. Additionally, the secrets may be transmitted with accompanying data or files attached.

The secrets management system 800 may also include an obfuscation module 840. The obfuscation module 840 obfuscate secret information in accordance with the various embodiments disclosed within this application. For example, the obfuscation module 840 may be configured to perform operations that are consistent with the steps described in FIGS. 2-6.

Generally, the obfuscation module 840 may obfuscate security data by performing one or more of the following processes: partitioning the security data into data shards, generating a plurality of obfuscated data shards by performing an obfuscation operation on each data shard of the plurality of data shards, generating a plurality of hash values by performing a hash function on each of the obfuscated data shards, generating a plurality of trace files, and transmitting the plurality of obfuscated data shards to a node in a data movement network. In some embodiments, each trace file may correspond to a different obfuscated data shard from the plurality of obfuscated data shards. Additionally, each hash value may identify a different obfuscated data shard of the plurality of obfuscated data shards.

In some embodiments, the obfuscation operation may include performing one or more of the following operations on the one or more data shards: encrypting the data shard, renaming the data shard using a name that is cryptographically generated, adding random data to the data shard, cyclically exclusive-or'ing (XOR'ing) the data shard, compressing the data shard, applying a permutation algorithm to the data shard, and applying a bit-scattering algorithm to the data shard. In some embodiments, the obfuscation operation may be performed on the secret information prior to partitioning the secret information.

The obfuscation module 840 may also retrieve obfuscated secret information. For example, the obfuscation module 840 may retrieve obfuscated secret information when it is requested by an authorized entity. In some embodiments, the obfuscation module 840 may perform one or more of the following operations to retrieve obfuscated secret information: receiving a request for the secret information, determining the data shards corresponding to the secret information by examining the generated plurality of trace files, sending the hash value identifying the data shards corresponding to the requested secret information to one or more nodes of the data movement network to cause the one or more nodes to transmit the requested security data to the exchange module, and generating the requested secret information using the data shards corresponding to the requested secret information.

The secrets management system 800 may also include an interface module 850. A robust and easy to use user interface (UI) and user experience (UX) are important for SaaS secrets management. The UI and UX facilitates for administrators to create, review, and modify security policies. Additionally, UI and UX are required where keys and secrets cannot be programmatically generated, such as with certain legacy services or resources.

The interface module 850 provides a user interface (UI) that allows users to perform one or more of: configure the management tasks, initiate the management tasks, configure the exchange of secret information, initiate the exchange of secret information, configure the obfuscation of the secret information, and initiate the obfuscation of the secret information. The interface module 850 facilitate operation within enterprise architectures that provide access control by human users. Human identities are important to access documents, spreadsheets, email, and other tools. In some examples, the interface module 850 may provide identity and access management (IAM) services for performing identity management and user access functions. In other examples, the IAM services may be provided by management module 820.

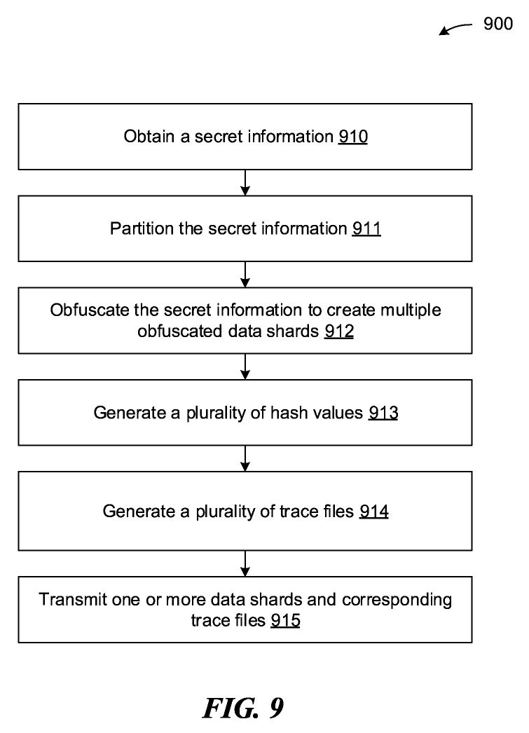

FIG. 9 is a flow diagram of a process 900 for managing secret information, consistent with various embodiments. In some embodiments, process 900 can be implemented in the environment 100 of FIG. 1. Additionally, process 900 can be performed by secrets management system 800 of FIG. 8. Generally, process 900 may include the steps described below. Additionally, or alternatively, process 900 may include various steps that are consistent with the steps described in FIGS. 1-4.

At block 910, a secrets management system obtains a secret information. In some embodiments, the secret information is a secret or cryptographic key. At block 911, the secrets management system partitions the secret information into a plurality of data shards. At block 912, the secrets management system generates a plurality of obfuscated data shards by performing an obfuscation operation on each data shard of the plurality of data shards. At block 913, the secrets management system generates a plurality of hash values by performing a hash function on each of the obfuscated data shards, each hash value identifying a different obfuscated data shard of the plurality of obfuscated data shards. At block 914, the secrets management system generates a plurality of trace files, each trace file corresponding to a different obfuscated data shard from the plurality of obfuscated data shards. At block 915, the secrets management system transmits a first obfuscated data shard from the plurality of obfuscated data shards and/or a first trace file corresponding to the first obfuscated data shard to a network device in a data movement network. Additional obfuscated data shards and corresponding trace files may be transmitted to additional nodes in the data movement network.

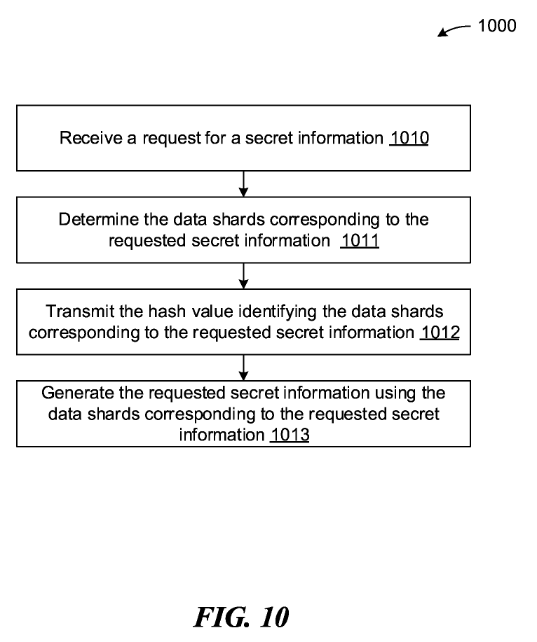

FIG. 10 is a flow diagram of a process 1000 for retrieving secret information, consistent with various embodiments. In some embodiments, process 1000 can be implemented in the environment 100 of FIG. 1. Generally, process 1000 may include the steps described below. Additionally, or alternatively, process 1000 may include various steps that are consistent with the steps described in FIG. 6.

At block 1010, a secrets management system receives a request for a secret information. In some embodiments, the request is received from a user using a user interface (UI). The user may access the secrets management system via an integrated identity and access management (IAM) service for performing identity management and user access functions. In other embodiments, the request is received from a programmatic request via an application programming interface (API) message. The API message may be from a database, computing resource, service provider, etc.

At block 1011, the secrets management system determines the data shards corresponding to the requested secret information by examining the generated plurality of trace files. At block 1012, the secrets management system transmits the hash value identifying the data shards corresponding to the requested secret information to one or more nodes of the data movement network to cause the one or more nodes to transmit the requested security data to the exchange module. At block 1013, the secrets management system generates the requested secret information using the data shards corresponding to the requested secret information.

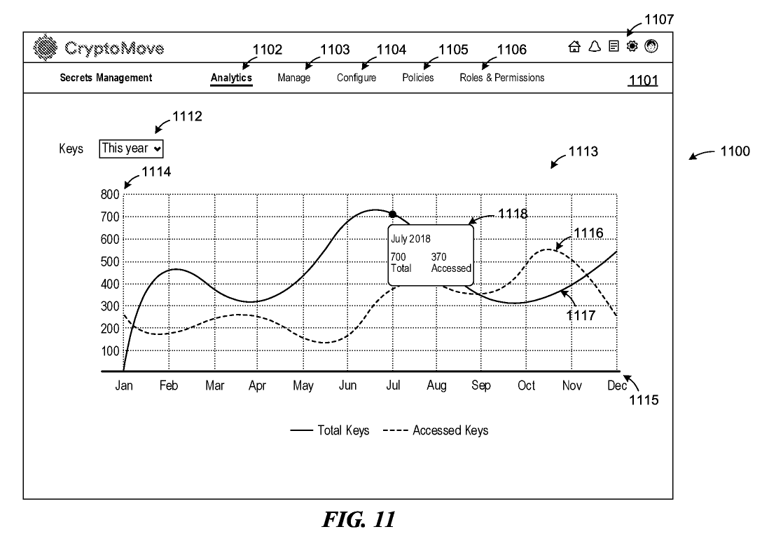

FIGS. 11-20 illustrate various user screens of a GUI for viewing and managing secrets information and devices according to some embodiments of the present disclosure. The user screens may be displayed on a user device such as a computer terminal, mobile device, wearable devices, etc. Additionally, the user screens may receive user input to navigate the screens, manipulate the display, enter user input, make selections, etc. In some embodiments, user input may be provided to the GUI using mouse clicks, audio commands, taps on a touch screen, physical gestures, etc.

FIG. 11 illustrates an example user screen 1100 of a graphical user interface (GUI) for viewing and managing secrets information, according to some embodiments of the present disclosure. User screen 1100 may be accessed by selecting the “analytics” tab on navigation bar 1101. Navigation bar 1101 may include buttons or tabs that may be used to access various screens of the GUI. In the illustrated example, navigation bar 1101 includes analytics tab 1102, manage tab 1103, configure tab 1104, policies tab 1105, and roles & permissions tab 1106. Additionally, windows configuration buttons 1107 may allow access to a home screen, notification settings, data settings, configuration settings, user settings, etc.

At user screen 1100, the user may use input panel 1112 (e.g., a drop-down menu, a text field, etc.) to select the time period that the user wishes to access. The selected period of time is displayed on graph 1113. For example, the user may select the desired time period to be the present year and graph 1113 will represent the year from January to December on x-axis 1115. Y-axis 1114 represents the data range that spans the selected period of time. For example, y-axis 1114 may represent the number of secrets information (e.g., cryptographic keys) that are accessed at a given time on x-axis 1115. Graph 1113 may display one or more data sets, such as the number of accessed keys 1116 and the total number of generated keys 1117. Additionally, detailed information may be displayed regarding specific data points along the data sets (e.g., data set 1116 and 1117). For example, data chart 1118 may display the number of keys accessed and the total number of keys generated in July 2018. In some embodiments, data chart 1118 may be dynamic and appear as the user selects specific data points (e.g., taps or hovers a mouse cursor over a data point) on chart 1113. A person of ordinary skill will recognize that various types of graphs and charts may be displayed to convey analytics information to perform secrets management.

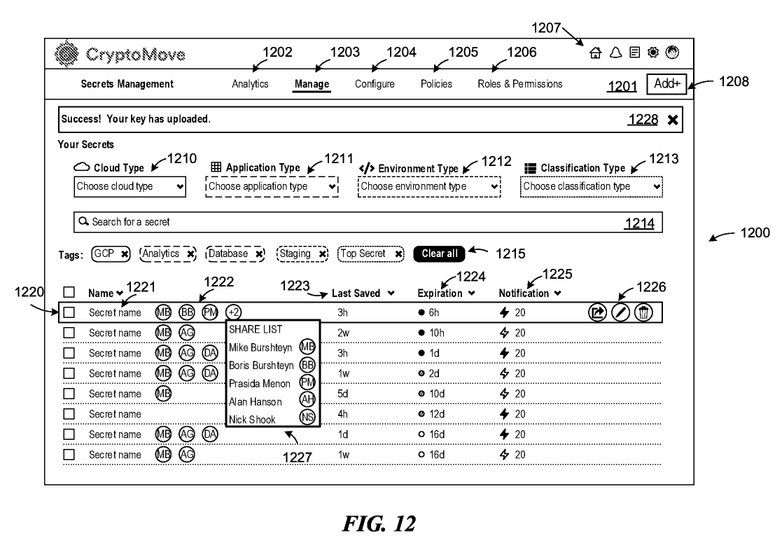

FIG. 12 illustrates an example user screen 1200 of a GUI for viewing and managing secret information, according to some embodiments of the present disclosure. User screen 1200 may be accessed by selecting the “manage” tab on navigation bar 1201. Navigation bar 1201 may include buttons or tabs that may be used to access various screens of the GUI. In the illustrated example, navigation bar 1201 includes analytics tab 1202, manage tab 1203, configure tab 1204, policies tab 1205, and roles & permissions tab 1206. Additionally, windows configuration buttons 1207 may allow access to a home screen, notification settings, data settings, configuration settings, user settings, etc. Add button 1208 may be accessed by a user to add secrets information, add navigation tabs, etc.

At user screen 1200, the user may select, view, and manage the various secrets information. In some embodiments, the user may select the secrets information to view by selecting categories associated with the desired secrets. For example, the user may use the cloud input panel 1210, application input panel 1211, environment input panel 1212, and classification input panel 1213 to select the secrets information to display on screen 1200. The user may also select the secrets information to view by inputting text to search for secret information using text search field 1214. Additionally, the user may select the secrets information to view by indicating tags associated with the desired secrets information using tags panel 1215.

Screen 1200 displays the secrets information selected by the user. In some embodiments, secrets information may be selected using input panels 1210-1213, text search field 1214, and/or tags panel 1215 as described above. In the illustrated example, secrets information may include secrets information 1220. The selected secrets information may be listed by its name along name column 1221.

The share list associated with each listed secrets information may be displayed on “share list” column 1222. Specifically, each secrets information may be associated with one or more share lists that indicate the list of users that has access to the secrets information. The share list associated with secrets information 1220 may be displayed on column 1222. For example, “share list” column 1222 may indicate that secrets information 1220 may be accessed by “Michael Burshteyn (MB),” “Boris Burshteyn (BB),” etc.

Additionally, last saved column 1223 may indicate the last time the secrets information was saved. For example, the last saved column 1223 may indicate the time that has elapsed since a cryptographic key was generated, modified, etc. The expiration column 1224 may indicate the time remaining until the secrets information expires. For example, expiration column 1224 may indicate the time remaining until a cryptographic key is no longer valid. Further, notification column 1225 may indicate the configuration of notifications for the secrets information. For example, notification column 1225 may indicate whether notifications are activated or allowed. Additionally, notification column 1225 may indicate the number of notifications that are sent. In some examples, the notifications may be sent when a secrets information is accessed, modified, set to expire, etc. Additionally, configuration buttons 1226 may be provided to control the various secrets information. In the illustrated example, configurations buttons 1226 may provide buttons for exporting, modifying, or deleting secrets information 1220. In some embodiments, a status update panel 1228 may be displayed. Status update panel 1228 may appear dynamically when a new event occurs or in response to a user input. In the illustrated example, status update panel 1228 appears to indicate that a key has been successfully uploaded.

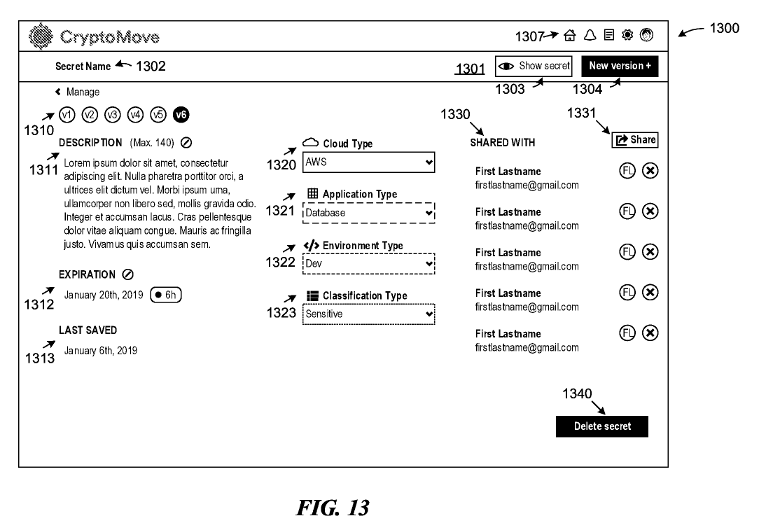

FIG. 13 illustrates an example user screen 1300 of a GUI for viewing and managing secrets information, according to some embodiments of the present disclosure. User screen 1300 may be accessed, in some examples, by selecting a secrets information listed in user screen 1200.

User screen 1300 includes secrets name bar 1301 for displaying the name of the secrets information currently displayed. In the illustrated example, secrets name bar 1301 displays the name of secrets information 1302. Additionally, show secret button 1303 and new version button 1304 may allow a user to show the selected secrets information or add a new version of the secrets information, respectively. Additionally, windows configuration buttons 1307 may allow access to a home screen, notification settings, data settings, configuration settings, user settings, etc.

Version buttons 1310 may display the various versions of a particular secrets information. The illustrated example shows six different versions of secrets information 1302. In some embodiments, the user may access the various buttons to display information associated with the selected secrets information version. Description panel 1311 may display information associated with the selected version of a secrets information. In some embodiments, the user may access an edit button to modify the information. Additionally, expiration panel 1312 may display the expiration time of the selected secrets information version. Further, last saved panel 1313 may display the time when the secrets information was last saved.

User screen 1300 may provide various panels for displaying or changing the properties of the selected secrets information version. Cloud type input panel 1320 may allow an user to select a cloud type associated with the selected secrets information. Application type input panel 1321 may allow a user to indicate an application type associated with the selected secrets information. Environment type input panel 1322 may allow a user to indicate an environment type associated with the selected secrets information. Finally, classification type input panel 1323 may allow a user to indicate the classification associated with the selected secrets information version. Shared users panel 1330 may display a list of users that has shared access to the selected secrets information version. In the illustrated example, shared users panel 1330 may display the full name, initials, and email address of each user listed. Additionally, a user may access a button to remove users from the list of users that has shared access. Further, share button 1331 may allow a user to add a user to the list of users that has shared access. Finally, delete secret button 1340 may allow a user to delete the selected secrets information.

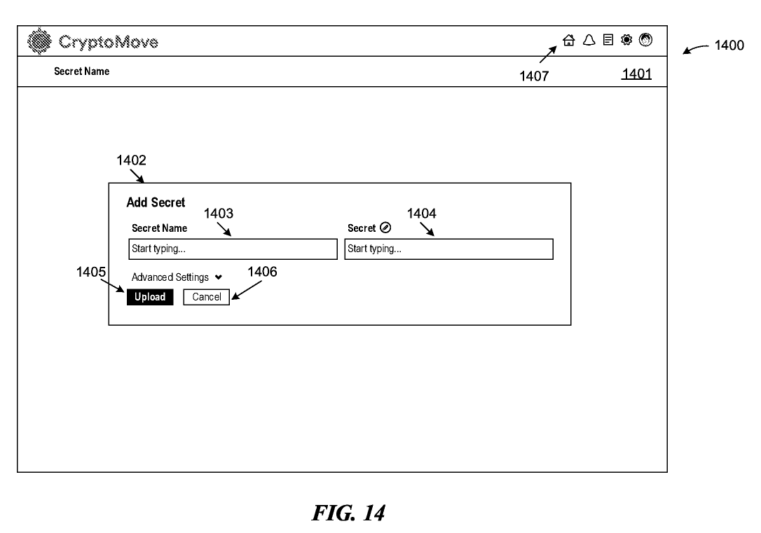

FIG. 14 illustrates an example user screen 1400 of a GUI for viewing and managing secret information, according to some embodiments of the present disclosure. In user screen 1400, windows configuration buttons 1407 may allow access to a home screen, notification settings, data settings, configuration settings, user settings, etc. Further, add secret window 1402 may be used by a user to input information regarding new secrets information. In the illustrated example, add secret window 1402 may include a secret name field 1403 and secret location field 1404. Secret name field 1403 may allow a user to input a text indicating the name of the secret. Further, secret field 1404 may allow a user to indicate the location, hash value, token value, or other information indicating the secrets information to add. Once secret name field 1403 and/or secret field 1404 has been completed, a user may select upload button 1405 or cancel button 1406 to continue with the process to add secrets information.

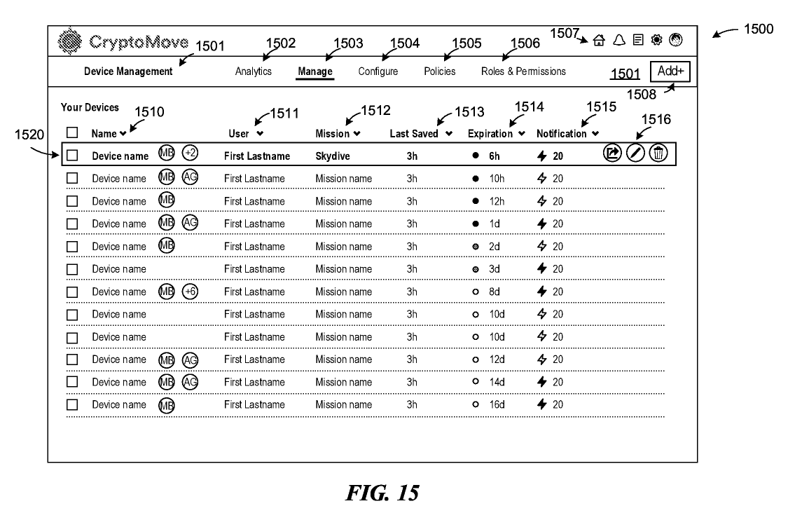

FIG. 15 illustrates an example user screen 1500 of a GUI for viewing and managing secret information, according to some embodiments of the present disclosure. User screen 1500 may be accessed by selecting the “manage” tab on navigation bar 1501. Navigation bar 1501 may include buttons or tabs that may be used to access various screens of the GUI. In the illustrated example, navigation bar 1501 includes analytics tab 1502, manage tab 1503, configure tab 1504, policies tab 1505, and roles & permissions tab 1506. Additionally, windows configuration buttons 1507 may allow access to a home screen, notification settings, data settings, configuration settings, user settings, etc. Add button 1508 may be accessed by a user to add secrets information, add navigation tabs, etc.

In the illustrated example, the devices that are managed in user screen 1500 may include device 1520. The managed devices may be listed by its name along device name column 1510. In some embodiments, the users that are associated with each device may be listed next to the device name in user column 1511. Mission column 1512 may be provided to display the mission associated with the device. The mission may indicate a project or task associated with the device. In the illustrated example, mission column 1512 lists the mission name “Skydive” for device 1520. The last saved column 1513 may be provided to display the last time the device configuration was saved. The expiration column 1514 may be provided to display the time until the device configuration expires. The notification column 1515 may be provided to display the configuration of notifications associated with the device listed in device name column 1510. For example, the notification configuration may indicate whether notifications are activated or allowed, the number of notifications that are sent, etc. Additionally, configuration buttons 1516 may be provided to control the various secrets information. In the illustrated example, configurations buttons 1516 may provide buttons for exporting, modifying, or deleting secrets information 1520.

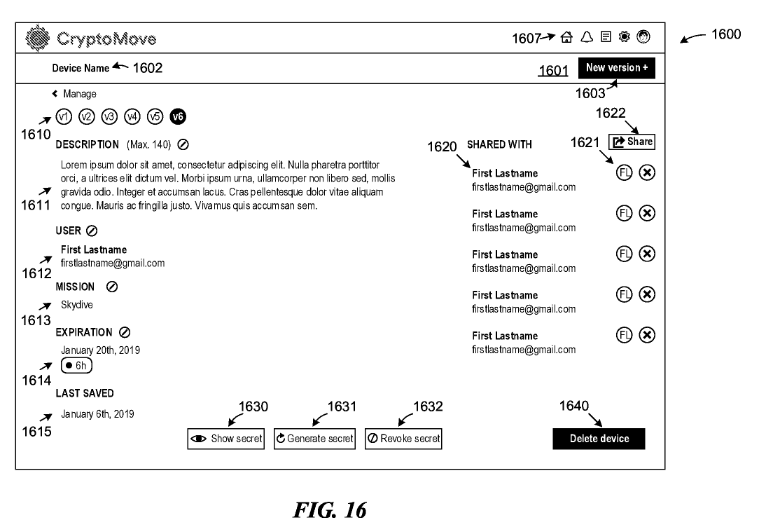

FIG. 16 illustrates an example user screen 1600 of a GUI for viewing and managing secret information, according to some embodiments of the present disclosure. User screen 1600 may be accessed, in some examples, by selecting a device listed in user screen 1500.

User screen 1600 includes device name bar 1601 for displaying the name of the device currently displayed. In the illustrated example, device name bar 1601 displays the name of device 1602. Additionally, new version button 1603 may allow a user to add a new version of the device. Additionally, windows configuration buttons 1607 may allow access to a home screen, notification settings, data settings, configuration settings, user settings, etc.

Version buttons 1610 may display the various versions of a particular device. The illustrated example shows six different versions of device 1602. In some embodiments, the user may access the various buttons to display information associated with the selected device version. Description panel 1611 may display information associated with the selected version of a device. In some embodiments, the user may access an edit button to modify the information. Additionally, user panel 1612 may display one or more users associated with device 1602. For example, the user's first name, last name, and/or contact information such as an email address may be listed in user panel 1612. Mission panel 1613 may display the mission or task associated with device 1602. In some embodiments, the mission may indicate a project or task associated with the device. In the illustrated example, the mission name “Skydive” is associated with device 1602. Expiration panel 1614 may display the expiration time of the selected device version. Further, last saved panel 1615 may display the time when the device version configuration was last saved.

User screen 1600 may provide various panels for displaying or changing the properties of the selected device version. Shared users panel 1620 may display a list of users that has shared access to the secrets information version. In the illustrated example, shared users panel 1620 may display the full name, initials, and email address of each user listed. Additionally, a user may access a button to remove users from the list of users that has shared access. Further, share button 1622 may allow a user to be added to the list of users that has shared access. Finally, delete device button 1640 may allow a user to delete the selected device version.

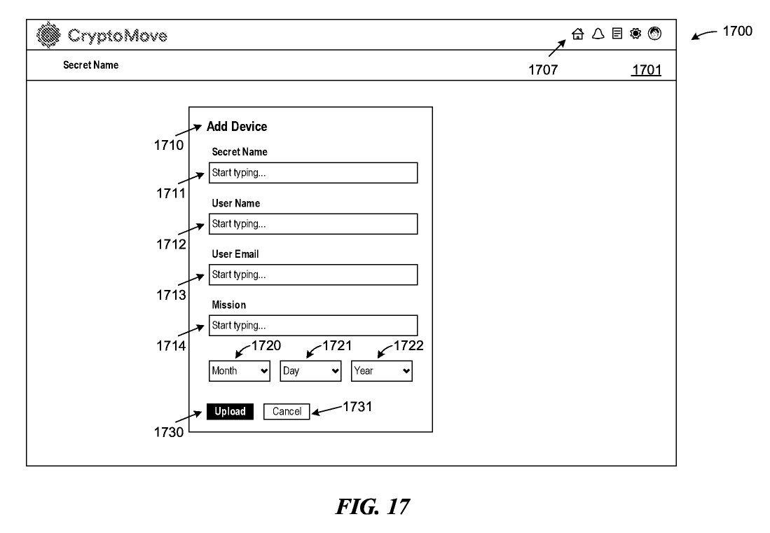

FIG. 17 illustrates an example user screen 1700 of a GUI for viewing and managing secret information, according to some embodiments of the present disclosure. In user screen 1700, windows configuration buttons 1707 may allow access to a home screen, notification settings, data settings, configuration settings, user settings, etc. Further, add device window 1710 may be used to input information to add a new device. In the illustrated example, add device window 1710 may include a secret name field 1711 for a user to input the secret name associated with the device to be added. Further, user name field 1712 may allow a user to input the user associated with the device to be added. User email field 1713 may allow a user to input an email address of the user associated with the device to be added. Mission field 1714 may allow a user to indicate the mission associated with the device to be added. Further, month field 1720, day field 1721, and/or day field 1722 may allow a user to indicate a date associated with the device to be added. For example, the date may indicate a time when the device starts or ends an association with a secrets information. Once information has been input into fields 1710-1714 and/or 1720-1722, a user may select upload button 1730 or cancel button 1731 to continue with the process to add a device version.

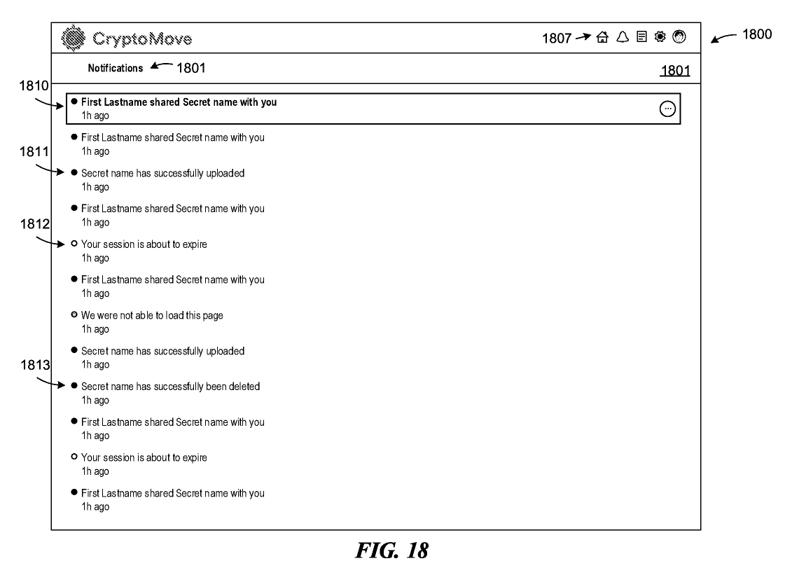

FIG. 18 illustrates an example user screen 1800 of a GUI for viewing and managing secret information, according to some embodiments of the present disclosure. In user screen 1800, notification information regarding secrets information or devices may be displayed. For example, shared notification 1810 may be displayed when a secrets information is shared. In the illustrated example, shared notification 1810 is displayed indicating that a secrets information was shared one hour ago by a particular user. Upload notification 1811 may be displayed when a secrets information is uploaded. Similarly, an expiration notification 1812 may be displayed when a secrets information or session is about to expire. Finally, delete notification 1813 may be displayed to indicate when a secrets information has been deleted. In some embodiments, options button 1814 may be provided for each notification that provides additional options such as deleting the notification, setting a reminder notification, etc.

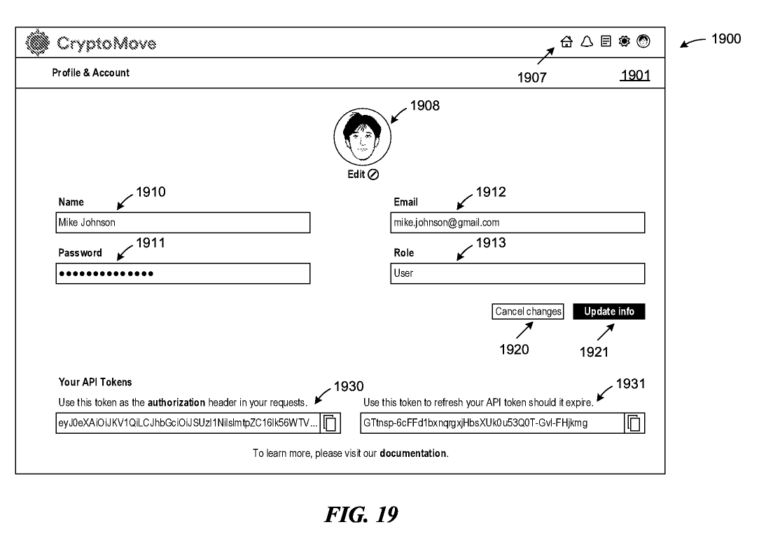

FIG. 19 illustrates an example user screen 1900 of a GUI for viewing and managing secret information, according to some embodiments of the present disclosure. In user screen 1900, profile and account information of the user using the GUI may be displayed and configured. Profile & account navigation bar 1901 indicates that the user is viewing profile and account information. Additionally, windows configuration buttons 1907 may allow access to a home screen, notification settings, data settings, configuration settings, user settings, etc.

In user screen 1900, a user avatar 1908 is displayed to indicate a graphical representation of the user. This may be useful for the user to determine how others will see the user. User avatar 1908 may be a photographic representation, illustration, line art, etc. A user name field 1910 may allow a user to input the name associated with the user account. Password field 1911 may allow a user to input a password to gain access to the account. User email field 1912 may allow a user to input an email address associated with the user account. Finally, user role field 1913 may be used to input the role associated with the user account. For example, the user role field 1913 may be used to indicate that the user account is associated with a user, a manager, administrator, etc. Cancel button 1920 and update button 1921 may allow a user to cancel the input that has been entered, or update the profile and account using the input that have been entered, respectively. The identifier of the user account may be provided using account identifier windows 1930 and 1931. In the illustrated example, account identifier window 1930 displays the API token that may be used as the authorization header in an access request. Similarly, account identifier window 1931 displays the API token used to refresh an expired API token. In some embodiments, other secrets information or identifier may be provided in user screen 1900.

While processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations, or may be replicated (e.g., performed multiple times). Each of these processes or blocks may be implemented in a variety of different ways. In addition, while processes or blocks are at times shown as being performed in series, these processes or blocks may instead be performed in parallel or may be performed at different times. When a process or step is “based on” a value or a computation, the process or step should be interpreted as based at least on that value or that computation.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

Physical and functional components (e.g., devices, engines, modules, and data repositories, etc.) associated with processing device 700, any of devices 125, 130, 155, or 185, etc., can be implemented as circuitry, firmware, software, other executable instructions, or any combination thereof. For example, the functional components can be implemented in the form of special-purpose circuitry, in the form of one or more appropriately programmed processors, a single board chip, a field programmable gate array, a general-purpose computing device configured by executable instructions, a virtual machine configured by executable instructions, a cloud computing environment configured by executable instructions, or any combination thereof. For example, the functional components described can be implemented as instructions on a tangible storage memory capable of being executed by a processor or other integrated circuit chip. The tangible storage memory can be computer readable data storage. The tangible storage memory may be volatile or non-volatile memory. In some embodiments, the volatile memory may be considered “non-transitory” in the sense that it is not a transitory signal. Memory space and storages described in the figures can be implemented with the tangible storage memory as well, including volatile or non-volatile memory.

Each of the functional components may operate individually and independently of other functional components. Some or all of the functional components may be executed on the same host device or on separate devices. The separate devices can be coupled through one or more communication channels (e.g., wireless or wired channel) to coordinate their operations. Some or all of the functional components may be combined as one component. A single functional component may be divided into sub-components, each sub-component performing separate method step or method steps of the single component.

In some embodiments, at least some of the functional components share access to a memory space. For example, one functional component may access data accessed by or transformed by another functional component. The functional components may be considered “coupled” to one another if they share a physical connection or a virtual connection, directly or indirectly, allowing data accessed or modified by one functional component to be accessed in another functional component. In some embodiments, at least some of the functional components can be upgraded or modified remotely (e.g., by reconfiguring executable instructions that implements a portion of the functional components). Other arrays, systems and devices described above may include additional, fewer, or different functional components for various applications.

1. A system for providing a software as a service (SaaS) secrets management service via a data movement network, the system comprising:
an inventory module, the inventory module storing the location of a secret information and the identity of authorized entities having permission to access the secret information, wherein the secret information may be one or more of: a cryptographic key, token, certificate, credential, configuration variable, environmental variable, application secret, and infrastructure secret;
a management module, the management module performing management tasks on the secret information, wherein the management tasks includes one or more of: generating, auditing, rotating, monitoring, configuring, and controlling access of the secret information;
an exchange module, the exchange module exchanging the secret information with the authorized entities, wherein the exchange module provides an application programming interface (API) to programmatically generate, configure, update, and/or exchange secret information, and wherein the authorized entities include one or more of: a user, a database, and a third-party service;
an obfuscation module, the obfuscation module obfuscating the secret information by:
partitioning the secret information into a plurality of data shards;
generating a plurality of obfuscated data shards by performing an obfuscation operation on each data shard of the plurality of data shards;
generating a plurality of hash values by performing a hash function on each of the obfuscated data shards, each hash value identifying a different obfuscated data shard of the plurality of obfuscated data shards;
generating a plurality of trace files, each trace file corresponding to a different obfuscated data shard from the plurality of obfuscated data shards; and
transmitting the plurality of obfuscated data shards and the corresponding trace plurality of trace files to a node in a data movement network; and
an interface module, the interface module providing a user interface (UI) that allows users to perform one or more of: configure the management tasks, initiate the management tasks, configure the exchange of secret information, initiate the exchange of secret information, configure the obfuscation of the secret information, and initiate the obfuscation of the secret information.

2. The system of claim 1, wherein the obfuscation operation includes performing one or more of the following operations on one or more of the plurality of data shards: encrypting the data shard, renaming the data shard using a name that is cryptographically generated, adding random data to the data shard, cyclically exclusive-or'ing (XOR'ing) the data shard, compressing the data shard, applying a permutation algorithm to the data shard, and applying a bit-scattering algorithm to the data shard.

3. The system of claim 1, wherein the obfuscation module is configured to retrieve the secret information requested by an authorized entity of the authorized entities by:
receiving a request for the secret information from the authorized entity;
determining the data shards corresponding to the secret information by examining the generated plurality of trace files;
sending the hash value identifying the data shards corresponding to the requested secret information to one or more nodes of the data movement network to cause the one or more nodes to transmit the requested security data to the exchange module; and
generating the requested secret information using the data shards corresponding to the requested secret information.

4. A system for providing secret information services, the system comprising:
an inventory module, the inventory module storing the location of a secret information and the identity of authorized entities having permission to access the secret information;
an exchange module, the exchange module exchanging the secret information with the authorized entities; and
an obfuscation module, the obfuscation module obfuscating the secret information by:
partitioning the secret information into a plurality of data shards;
generating a plurality of obfuscated data shards by performing an obfuscation operation on each data shard of the plurality of data shards;
generating a plurality of hash values by performing a hash function on each of the obfuscated data shards, each hash value identifying a different obfuscated data shard of the plurality of obfuscated data shards;
generating a plurality of trace files, each trace file corresponding to a different obfuscated data shard from the plurality of obfuscated data shards; and
transmitting the plurality of obfuscated data shards to a node in a data movement network.

5. The system of claim 4, further comprising:
a management module, the management module performing management tasks on the secret information, wherein the management tasks includes one or more of: generating, auditing, rotating, monitoring, configuring, and controlling access of the secret information.

6. The system of claim 4, further comprising:
an interface module, the interface module providing a user interface (UI) that allows users to perform one or more of: configure the management tasks, initiate the management tasks, configure the exchange of secret information, initiate the exchange of secret information, configure the obfuscation of the secret information, and initiate the obfuscation of the secret information.

7. The system of claim 4, wherein the secret information is one or more of: a cryptographic key, token, certificate, credential, configuration variable, environmental variable, application secret, and infrastructure secret.

8. The system of claim 4, wherein the obfuscation operation includes performing one or more of the following operations on one or more of the plurality of data shards: encrypting the data shard, renaming the data shard using a name that is cryptographically generated, adding random data to the data shard, cyclically exclusive-or'ing (XOR'ing) the data shard, compressing the data shard, applying a permutation algorithm to the data shard, and applying a bit-scattering algorithm to the data shard.

9. The system of claim 4, wherein the obfuscation module is configured to retrieve the secret information requested by an authorized entity of the authorized entities by:
receiving a request for the secret information from the authorized entity;
determining the data shards corresponding to the secret information by examining the generated plurality of trace files;
sending the hash value identifying the data shards corresponding to the requested secret information to one or more nodes of the data movement network to cause the one or more nodes to transmit the requested security data to the exchange module; and
generating the requested secret information using the data shards corresponding to the requested secret information.

10. The system of claim 4, wherein the entities include one or more of: a user, a database, and a third-party service.

11. The system of claim 4, wherein the management module rotates the secret information by automatically updating the secret information or creating a new version of the secret information and wherein the obfuscation module automatically obfuscates the updated secret information.

12. The system of claim 4, wherein the management module controls the access of secret information using integrated identity and access management (IAM) services for performing identity management and user access functions.

13. The system of claim 4, wherein the exchange module provides an application programming interface (API) to programmatically generate, configure, update, and exchange secret information.

14. A method for providing secret information services, the method comprising:
obtaining a secret information, wherein the secret information is a secret or cryptographic key;
partitioning the secret information into a plurality of data shards;
generating a plurality of obfuscated data shards by performing an obfuscation operation on each data shard of the plurality of data shards;
generating a plurality of hash values by performing a hash function on each of the obfuscated data shards, each hash value identifying a different obfuscated data shard of the plurality of obfuscated data shards;
generating a plurality of trace files, each trace file corresponding to a different obfuscated data shard from the plurality of obfuscated data shards; and
transmitting a first obfuscated data shard from the plurality of obfuscated data shards and a first trace file corresponding to the first obfuscated data shard to a network device in a data movement network.

15. The method of claim 14, wherein the secret information is one or more of: a cryptographic key, token, certificate, credential, configuration variable, environmental variable, application secret, and infrastructure secret.

16. The method of claim 14, wherein the obfuscation operation includes performing one or more of the following operations on one or more of the plurality of data shards: encrypting the data shard, renaming the data shard using a name that is cryptographically generated, adding random data to the data shard, cyclically exclusive-or'ing (XOR'ing) the data shard, compressing the data shard, applying a permutation algorithm to the data shard, and applying a bit-scattering algorithm to the data shard.

17. The method of claim 14, further comprising:
receiving a request for the secret information;
determining the data shards corresponding to the secret information by examining the generated plurality of trace files;
transmitting the hash value identifying the data shards corresponding to the requested secret information to one or more nodes of the data movement network to cause the one or more servers to transmit the requested security data to the exchange module; and
generating the requested secret information using the data shards corresponding to the requested secret information.

18. The method of claim 17, wherein the secret information is generated based upon the request from a user interface (UI) or a programmatic request made via an application programming interface (API) message.

19. The method of claim 18, wherein the request is received from the UI operated by a user accessing the secret information services via an integrated identity and access management (IAM) service for performing identity management and user access functions.

20. The method of claim 18, wherein the API message is received from a database, computing resource, or service provider.

21. A computer-readable storage medium storing computer-readable instructions, comprising:
instructions for obtaining a secret information, wherein the secret information is a secret or cryptographic key;
instructions for partitioning the secret information into a plurality of data shards;
instructions for generating a plurality of obfuscated data shards by performing an obfuscation operation on each data shard of the plurality of data shards;
instructions for generating a plurality of hash values by performing a hash function on each of the obfuscated data shards, each hash value identifying a different obfuscated data shard of the plurality of obfuscated data shards;
instructions for generating a plurality of trace files, each trace file corresponding to a different obfuscated data shard from the plurality of obfuscated data shards; and
instructions for transmitting a first obfuscated data shard from the plurality of obfuscated data shards and a first trace file corresponding to the first obfuscated data shard to a network device in a data movement network.

22. The computer-readable storage medium of claim 21, further comprising:
instructions for receiving a request for the secret information;
instructions for determining the data shards corresponding to the secret information by examining the generated plurality of trace files;
instructions for sending the hash value identifying the data shards corresponding to the requested secret information to one or more nodes of the data movement network to cause the one or more servers to transmit the requested security data to the exchange module; and
instructions for generating the requested secret information using the data shards corresponding to the requested secret information.
